(19) United States
(12) Patent Application Publication
(10) Pub. No.: US 2012/0004769 A1
(43) Pub. Date: Jan. 5, 2012

(54) AUTOMATED RETAIL SHELF UNITS AND SYSTEMS

(75) Inventors: Chris Hallenbeck, Palo Alto, CA (US); Jennifer Stephan, San Francisco, CA (US); Joel Lindheimer, Moraga, CA (US); Guillermo Trejo, San Jose, CA (US); Robert Taff, Oakland, CA (US); Sean Machin, Petaluma, CA (US); Russ Yoshinaka, Walnut Creek, CA (US)

(73) Assignee: NEWZOOM, INC., San Francisco, CA (US)

(21) Appl. No.: 13/229,537

(22) Filed: Sep. 9, 2011

Related U.S. Application Data
(63) Continuation-in-part of application No. 12/603,809, filed on Oct. 22, 2009.
(60) Provisional application No. 61/485,758, filed on May 13, 2011.
(60) Provisional application No. 61/107,599, filed on Oct. 22, 2008.

(51) Int. Cl. G06F 17/00

(52) U.S. Cl. 700/232

(57) ABSTRACT

Provided are automated retail shelf (ARS) units and corresponding network systems for facilitating retail of various product items in retail environments. An ARS unit includes a chassis sized and configured for attaching to a retail shelf unit and being supported by the shelf unit at an elevated level convenient for customer interactions. The ARS unit may be positioned in a retail aisle among other product items, for example, unsecured product items. The ARS unit provides secure storage to specific product items available for sale from the unit. These product items may have high values and be more susceptible to theft unlike other unsecured product items available from retail shelves. The ARS unit may be used to provide information about product items stored in the unit and, in certain embodiments, unsecured product items available from retail shelves, such as indicating location of these items in the retail environment.

### CROSS-REFERENCE TO RELATED APPLICATIONS

This application claims the benefit under 35 U.S.C. §119(e) of U.S. Provisional Patent Application 61/485,758, entitled: “AUTOMATED RETAIL SHELF UNITS AND SYSTEMS,” filed on May 13, 2011, which is incorporated herein by reference in its entirety.

This application is also a continuation-in-part of U.S. application Ser. No. 12/603,809, entitled “VENDING STORE INVENTORY MANAGEMENT AND REPORTING SYSTEM,” filed on Oct. 22, 2009, (Attorney Docket No. ZOOMP003US), which claims the benefit under 35 U.S.C. §119(e) of U.S. Provisional Patent Application 61/107,599, entitled: “VENDING STORE INVENTORY MANAGEMENT AND REPORTING SYSTEM,” filed on Oct. 22, 2008, (Attorney Docket No. ZOOMP003PUS). Both of these applications are incorporated herein by reference in their entirety.

### BACKGROUND

Automated vending equipment has gained wide acceptance among retailers and customers. Vending equipment is typically inexpensive to operate and occupies relatively little space in comparison with other retail operations. It does not require much human intervention and supervision, such as the store clerks needed in traditional retail outlets. However, conventional vending machines have limited capabilities and are generally unsuitable for vending expensive products, such as cosmetics and consumer electronics. As a result, traditional vending machines are relegated to dispensing inexpensive produces such as soft drinks, candies, and newspapers. Further, it is not uncommon for vending machines to dispense the wrong product items or no products at all. Such deficiencies of vending machines may be tolerated to some degree by the customers because the vended items tend to have low prices.

### SUMMARY

Provided are automated retail shelf (ARS) units and corresponding network systems for facilitating the retail of various product items in retail environments. An ARS unit includes a chassis sized and configured for attaching to a retail shelf unit and being supported by the shelf unit at an elevated level convenient for customer interactions. The ARS unit may be positioned in a retail aisle among other product items (for example, unsecured product items). The ARS unit provides secure storage to specific product items available for sale from the unit. These product items may have high values and be more susceptible to theft, unlike other, unsecured product items available from retail shelves. The ARS unit may be used to provide information about product items stored in the unit and, in certain embodiments, unsecured product items available from retail shelves (such as indicating the location of these items in the retail environment).

In certain embodiments, an ARS unit includes a chassis sized and configured to fit on an elevated shelf in a retail environment and a product storage compartment for securely storing one or more saleable product items within the chassis. The ARS unit also includes a user interface section provided on the front side of the chassis and configured to face a customer in the retail environment. In certain embodiments, the user interface section includes a detecting feature for detecting a customer selection of a product item available from the product storage compartment; a payment feature for accepting and processing a cashless payment from the customer for the selected product; and a dispensing feature for dispensing the product item selected and paid for by the customer.

An ARS unit may include an additional product storage compartment such that the user interface section is provided in between the two product storage compartments. In these embodiments, the two product storage compartments and user interface section may be arranged along the length of the chassis. This length may be longer than the height of the chassis.

In certain embodiments, a detecting feature includes a touch screen. In the same or other embodiments, a payment feature includes a card reader and logic for communicating with a payment switch. A dispensing feature may include a ramp for delivering product items from the product storage compartment. In certain embodiments, an ARS unit includes a processor and electronic memory. The electronic memory may store logic, executable by the processor, for communicating between the processor and a data center located outside the retail environment. In certain embodiments, the processor and/or the memory are configured to identify to the customer via the user interface section one or more product items for purchase by the customer. The one or more identified product items are located with the retail environment outside of the ARS unit. The processor and/or the memory may be configured to provide to the customer, via the user interface section, information about the location of the identified one or more product items in the retail environment.

In certain embodiments, a chassis of the ARS unit includes a display for presenting product information corresponding to the one or more saleable product items within the chassis. The display may be located outside the user interface section. In the same or other embodiments, a dispensing feature is configured to prevent unauthorized retrieval of product items from the product storage compartment.

An ARS unit may be configured for automated collection of inventory information corresponding to the remaining numbers of one or more saleable product items in the secure storage location. In certain embodiments, an ARS unit is configured to report the inventory information to another computer system in the retail environment. An ARS unit may include a barcode scanner for scanning the barcodes of one or more saleable product items while these items are being dispensed by the dispensing feature. The barcode scanner may be configured for scanning barcodes of product items available in the retail environment outside of the ARS unit. Furthermore, the user interface section may be configured to provide product information corresponding to the scanned barcodes of the product items available in the retail environment outside of the ARS unit.

Provided is an ARS unit for vending product items to customers including a back side having at least two support hooks for attaching to posts of a retail shelving unit, two product storage compartments attached to the back side, and a user interface section attached to the back side and positioned in between the two product storage compartments. The two support hooks of the back side are positioned at a distance of between about 2 feet and 5 feet. The two product storage compartments are configured for storing the product items in a secure manner such that the two product storage compartments include between 2 and 30 product bins. Each product bin is configurable to store a different kind of product item and is equipped with a delivery mechanism. The user interface section includes a touch screen, a payment mechanism comprising a credit card acceptor and a receipt printer, and a product delivery bin for delivering a purchased product item and preventing unauthorized retrieval of other product items. A portion of the product delivery is open to the product compartments of the two product storage compartments.

Also provided is a method of purchasing an product item from an ARS unit involving detecting customer selection of a product item available from a product storage compartment of the ARS unit, accepting and processing a cashless payment from the customer for the selected product using a payment feature of the user interface section, and dispensing the product item selected and paid for by the customer using a dispensing feature of the user interface section. The detecting operation may be performed by a detecting feature of a user interface section provided on a front side of a chassis of the ARS unit. The product storage compartment securely stores one or more saleable product items within the chassis. The chassis of the ARS unit is sized and configured to fit on an elevated shelf in a retail environment.

These and other embodiments are described further below with reference to the figures.

### BRIEF DESCRIPTION OF THE DRAWINGS

FIG. 1 illustrates two ARS units located in a middle of the conventional retail aisle and attached to a conventional retail shelf unit, in accordance with certain embodiments.

FIG. 2 is a schematic front view of an ARS unit, in accordance with certain embodiments.

FIG. 3 is a schematic perspective view of an ARS unit showing a support feature provided on the back side of the ARS unit, in accordance with certain embodiments.

FIGS. 4A and 4B are schematic front and side views of a retail shelf unit for supporting ARS units, in accordance with certain embodiments.

FIG. 5 is a schematic perspective view of an ARS unit with access doors opened and illustrating various internal features of the ARS unit, in accordance with certain embodiments.

FIGS. 6A and 6B are two schematic side views of different ARS units illustrating different relative locations of user interfaces areas, in accordance with certain embodiments.

FIGS. 7A-7H are perspective views of different ARS units illustrating different locations and orientations of user interfaces areas as well as other components, in accordance with certain embodiments.

FIG. 8 is a block diagram of a network system illustrating various communication links within the retail environment and outside of the retail environment, in accordance with various embodiments.

FIG. 9 illustrates a computational hardware arrangement and associated interconnections within an ARS unit, in accordance with certain embodiments.

FIG. 10 is an electronic schematic diagram of an ARS unit's hardware, in accordance with certain embodiments.

FIG. 11 is block diagram representing a multilayer architecture of the software implemented on an ARS unit, in accordance with certain embodiments.

FIG. 12 is a block diagram illustrating various ARS unit components and their interrelationships, in accordance with certain embodiments.

FIG. 13 is a block diagram of a network system including one or more ARS units, in accordance with certain embodiments.

FIG. 14A is a schematic representation of a “screensaver” example that may include an attract loop and various screen elements, in accordance with certain embodiments.

FIG. 14B is a schematic representation of a “home screen,” in accordance with certain embodiments.

FIG. 14C is a schematic representation of a “product category screen,” in accordance with certain embodiments.

FIG. 14D is a schematic representation of a “product screen,” in accordance with certain embodiments.

FIG. 15 is a flowchart corresponding to a process by which an ARS unit may respond to customer actions, in accordance with certain embodiments.

FIG. 16 is a block diagram illustrating interactions among various entities involved in managing an inventory of ARS units, in accordance with certain embodiments.

FIG. 17 is a flowchart corresponding to a process for collecting data from different components of a networked system and presenting this data to authorized users, in accordance with certain embodiments.

FIG. 18 is a schematic representation of a digital apparatus for use in an ARS unit, in accordance with certain embodiments.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### Introduction

Retailers face significant challenges with maintaining control over certain product categories, including high value items that are routinely stolen from their stores. This problem is sometimes referred to as product “shrink” or “shrinkage” and is attributable to both customers and retail personnel. One such category includes razor blades, which are expensive, have small packages, and can be resold on the black market. This particular product category is amongst the most stolen product items in various retail chains today. Many other similar products are also susceptible to theft, which results in higher prices to compensate for stolen goods and the implementation of preventive measures.

To prevent theft, retailers use various “defensive merchandising methods,” which are typically based on restricting access in the retail environment to the actual product items. Some methods include locking product items in secure cabinets accessible only to retail clerks, temporary placing product items in large-format cases that are only opened at the checkout, and installing specific devices that dispense one product item at a time to limit the number of stolen goods. In certain situations, products are taken off retail shelves and placed behind the service desk without any direct access by consumers, which limits exposure of these products to the customer. Many of these “defensive merchandising methods” provide only limited benefits against theft and products continue to be stolen by customers and distributor and/or retailer personnel. Furthermore, these methods limit the products' exposure (e.g., placing product items on conventional retail shelves) and interfere with a customer's product selection and purchasing processes. There is a strong belief that customers are less likely to purchase products protected by these methods.

Provided are an ARS unit and corresponding ARS system integrating one or more ARS units positioned in the same retail environment. ARS units are designed for fast, convenient, and secure transactions with customers without involving retail clerks as well as improved product availability and accessibility through less “defensive” merchandising methods. ARS units and systems are designed to improve the customers' experiences and drive up a number of sale transactions, reduce product theft, and automatically control the inventory.

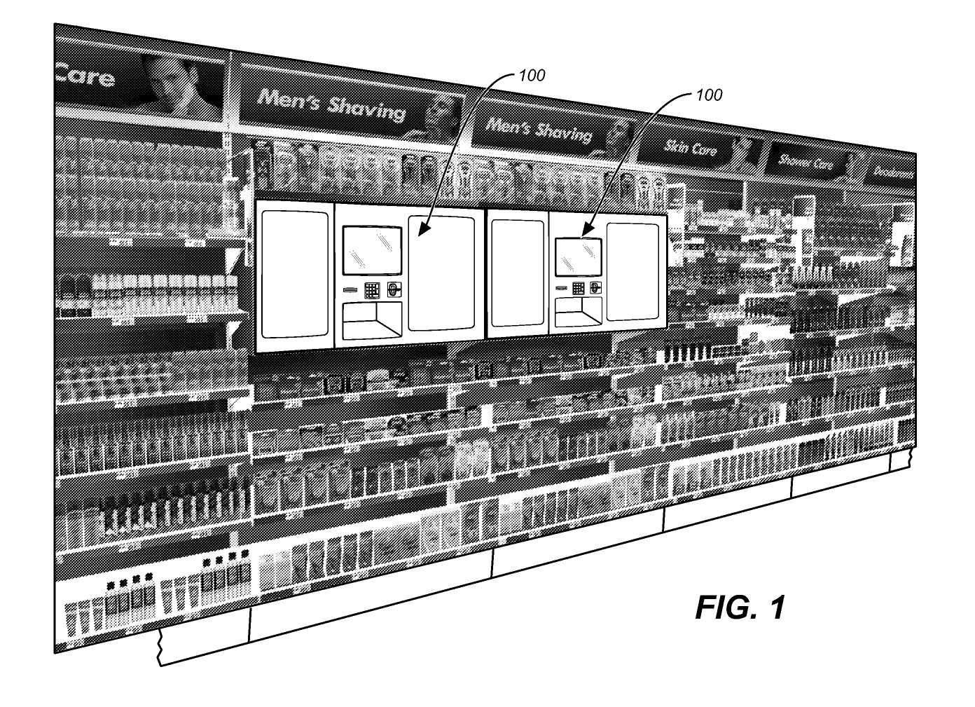

The proposed ARS units and systems are suitable for various retail environments, such as grocery stores, convenience stores, and many others. Typically, such retail environments include conventional retail shelf units used for storing unsecured products. ARS units are integratable with the existing unsecured shelves and can be installed in any part of the retail aisle along with the other shelves. For example, one or more of the existing unsecured shelves may be removed to form an opening and to position an ARS unit in that place. Alternatively, the ARS may be mounted on an existing shelf, without needing to remove a portion of the shelf. FIG. 1 illustrates two ARS units located in a middle of the conventional retail aisle and attached to a conventional retail shelf unit, in accordance with certain embodiments. For example, this retail aisle may be used to display and store various shaving supplies. In this example, the two ARS units may be used to store high value items, such as razor blades, while the surrounding unsecured shelves may be used to store other lower priced items, such as shaving creams and lotions. The ARS units may be also used to direct customers to various product items provided in the unsecured shelves as further explained below.

Once an ARS unit is attached to the retail shelf unit (e.g., shelf posts), plugged into a conventional electrical outlet, and connected for communication (e.g., wirelessly) with other components of the ARS system, a convenient, fast, and secure point-of-sale (POS) is established in this retail environment. ARS units may be positioned at any location of the retail environment and may store various product items having various sized packages and values. An ARS unit may help to reduce product theft and the need for additional help from retail clerks, while providing high exposure to the product items and the additional capability of delivering product information to the customers. In fact, ARS units may automate some operations previously performed by retail clerks, such as providing product information, scanning prices, locating certain product items within the retail environment, issuing coupons, and the like. Overall, ARS units are designed to reduce product theft and improve the sales of high value items, as well as perform other functions described in this document.

A retail environment is defined as a predetermined geographic boundary used for selling or leasing physical goods (and, perhaps, complementary services) in some collaborative manner. For example, a retail environment may include a shared facility, such as a building, and/or certain shared services, such as checkout points. Examples of retail environments include various types of stores (e.g., malls, outlets, warehouse clubs, grocery stores, convenience stores, drug stores, mass merchandise outlets, gas stations, and the like) as well as other enclosed or otherwise bounded retail facilities (e.g., open-air markets, bazaars, fairs, and the like). Specific features of a retail environment relevant to the functionality of ARS units and systems are product item storage and presentation (e.g., secured and unsecured), product selection process, tender of payment process, and product dispensing/delivering mechanisms. These are just a few main features of the retail environments. Some retail environments provide very close supervision over product items by retail clerks, while others allow their customers to operate independently during at least product selection, such as a department store or a grocery store. The later product environments tend to be more common as they allow substantial labor savings. However, these environments allow unobstructed access to product items and are often associated with product theft.

ARS units and systems allow seamless integration into different retail environments to improve transactional efficiencies and address some of the problems listed above. ARS units provide secure storage for various kinds of product items. Multiple different stock keeping units (SKUs) may be presented in one ARS unit. Furthermore, a retailer may position multiple ARS units in the same retail environment as, for example, shown in FIG. 1. Multiple ARS units in the same retail environment may be grouped together into a single ARS system for technical, logistic, and other efficiency reasons as further explained below. Each ARS unit includes a user interface (UI) allowing customers to independently (i.e., without retail clerks) select, purchase, and retrieve product items from the ARS unit. Customers do not need to wait for secure cabinets to be opened, carry bulky boxes to a service desk, or wait in line at the service desk to complete rather simple purchasing transactions.

Various aspects of ARS units and systems may be conceptually divided into structural features and functional features, many of which are interdependent. For example, structural features reflect different physical components of the ARS units, such as components for attachment to retail shelving, securing product items, displaying product information, accepting payment information, and dispensing product items. Certain functional and logical aspects of ARS units and systems are similar or identical to those of automated retail vending stores, which are described in U.S. application Ser. No. 12/603,809, entitled “VENDING STORE INVENTORY MANAGEMENT AND REPORTING SYSTEM,” filed on Oct. 22, 2008, (Attorney Docket No. ZOOMP003US), incorporated herein by reference in its entirety for purposes of describing vending stores.

### Structural Features of ARS Units

A typical ARS unit includes a physical enclosure, controls, software, a communication system, and content. The physical enclosure may be a box or chassis capable of fitting into and attaching to conventional retail shelving and enclosing other components of the ARS unit. The physical enclosure is used to store product items in a secured manner. The controls of the ARS unit are used for interacting with customers, accepting and transacting payments, dispensing product items, and optionally providing many other functions. The controls may be provided via hardware, software, or various combinations of software and hardware as described below. The ARS unit is configured to communicate with other internal and/or external components to process payment information, update its content (e.g., product information), and deliver transactional data (e.g., sales, clickstreams).

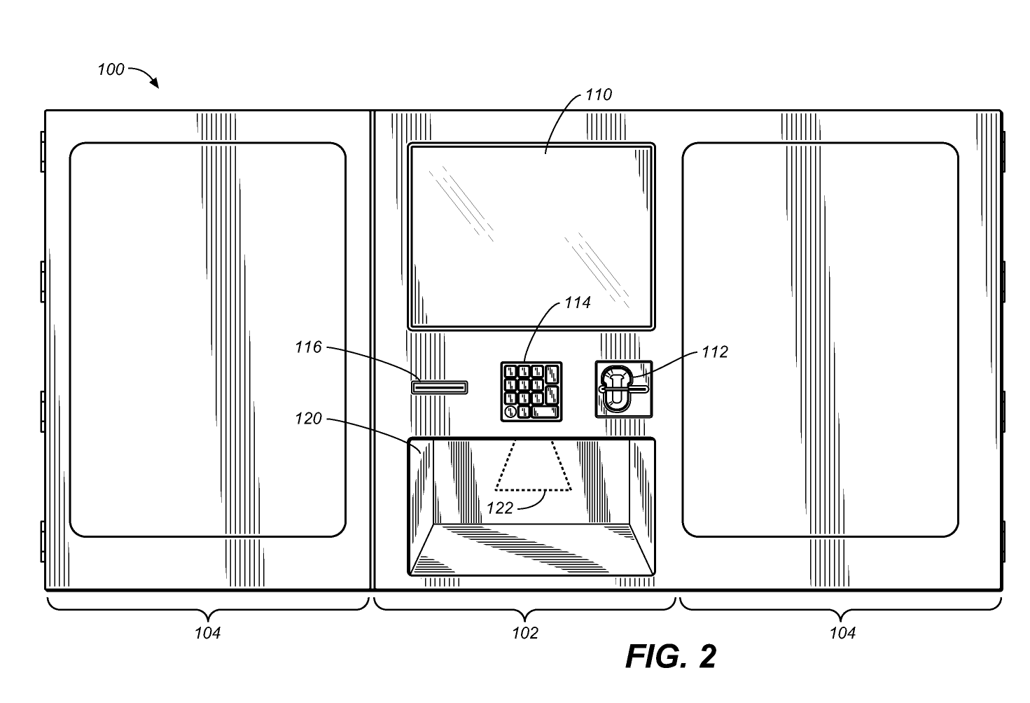

FIG. 2 presents a schematic front view of an ARS unit 100, in accordance with certain embodiments. ARS unit 100 is shown to have two product storage compartments 104 and a UI section 102. Product storage compartments 104 may be referred to as “product modules,” while UI section 102 may be referred to as a “control module.” Product storage compartments 104 and UI section 102 may be permanently integrated or have some kind of modular design. For example, product storage compartments 104 may be swapped in and out of the physical enclosure.

UI section 102 may be positioned between two product storage compartments 104 as shown in FIG. 2. This embodiment allows customers to focus on UI section 102 and be less distracted by the surrounding retail environment. Furthermore, the front faces of two product storage compartments 104 may be used to provide additional information to customers while the customers interact with UI section 102. Positioning UI section 102 in between two product storage compartments 104 allows for delivering product items (through UI section 102) from both product storage compartments 104 and provides better weight distribution, as described below. In certain embodiments, an ARS unit has only one product storage compartment. In other embodiments, an ARS unit has two product storage compartments having different sizes.

Each product storage compartment 104 includes one or more product bins for storing product items. The product bins are partially enclosed by a front access door, which is securely attached to and a part of product storage compartment 104. In certain embodiments, each product storage compartment 104 has its own designated access door. In other embodiments, product storage compartment 104 may share its access door with UI section 102. The shared door provides access (at the same time) to the product bins inside the product storage compartment and various internal components of UI section 102, such as its product delivery chute and/or ramp. In certain embodiments, an ARS unit has one access door shared by all product storage compartments and UI section.

In addition to providing secure product storage, access doors or, more specifically, their front panels, may be used to display various product information (e.g., advertising), display product items, display content intended to attract customers, and be used for other marketing purposes. These and related features are collectively referred to as “provisional branded aesthetics.” To implement these features, front panels of the access doors may include product compartments for placing products (e.g., one or more lighted shelves) and/or structural features for attaching product images (e.g., hangers or transparent “envelopes” for inserting product posters). An access door may have a video display (e.g., liquid crystal display). In other embodiments, an access door may include a transparent window allowing customers to view actual product items inside the ARS unit or, more specifically, product items positioned in the product bins. Viewing actual product items may play an important role in customers' purchasing decisions, similar to viewing and being able to access product items available on conventional unsecured shelves.

An access door may include a lock or another mechanism for restricting access to product storage compartments 104. A locking mechanism may prevent access during regular operation except during certain defined events, such as replenishing inventory and performing maintenance. Various levels of access may be granted. In certain embodiments, different product storage compartments 104 have separate access doors with different levels of access based, for example, on different product value, different brands, and/or different product categories. Restocking and service personnel may have different access privileges permitting access to one particular product storage compartment and not the other, for example. Such differentiation may allow ARS operators to achieve better control over their inventory and prevent product theft. Overall, product items need to be secured not only from customers but from some retail personnel, and the restricted access control may help to mitigate this problem.

Access to product storage compartments 104 may be controlled based on the receiving and verifying of certain identifiers. One example of an identifier is a limited distribution mechanical key. Different compartments may have locks that require different keys. In other embodiments, ARS unit 100 uses electronic access cards with programmable codes, access codes/personal identification numbers (PIN), and biometrics inputs including facial features, fingerprints, iris recognition, voice recognition, or other examples of unique identifiers. Access information may be maintained dynamically and updated during data exchange sessions between ARS unit 100 and, for example, an external data center.

UI section 102 may be configured to deliver information to customers, collect and process information from customers, and control product dispensing. UI section 102 may include a controller or at least be connected to a controller, such as a computer system or processor. A portion of the controller/computer system may be physically positioned in other parts of ARS unit 100 or other ARS units altogether as further explained below with reference to FIG. 2. In certain embodiments, one or more controller parts are shared by multiple ARS units.

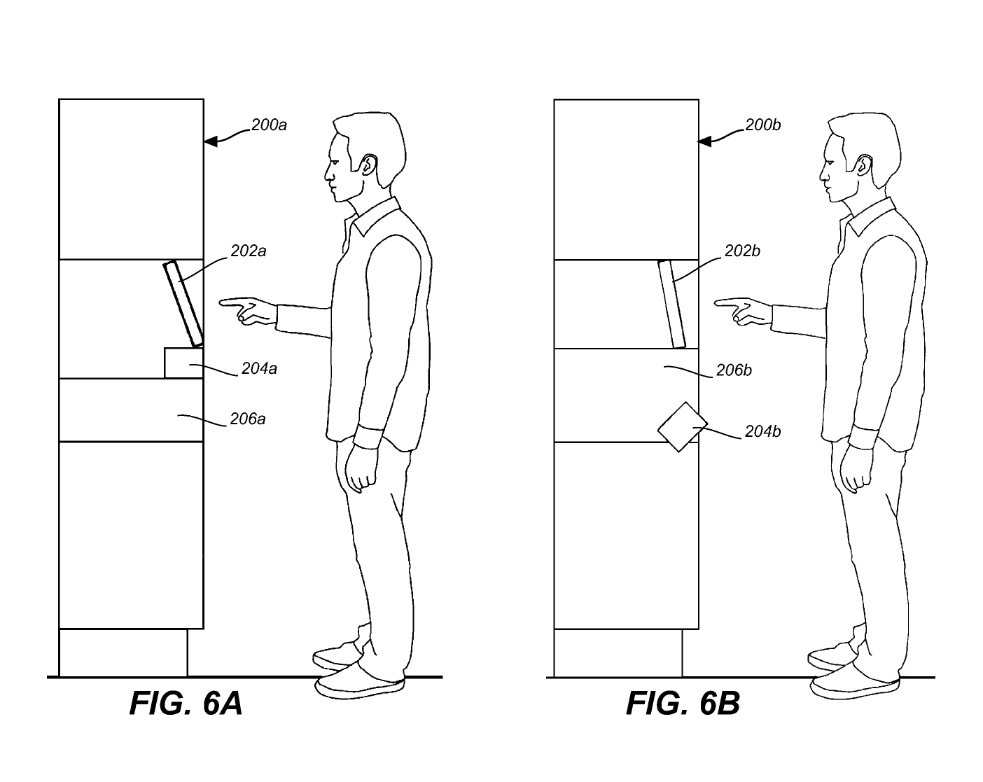

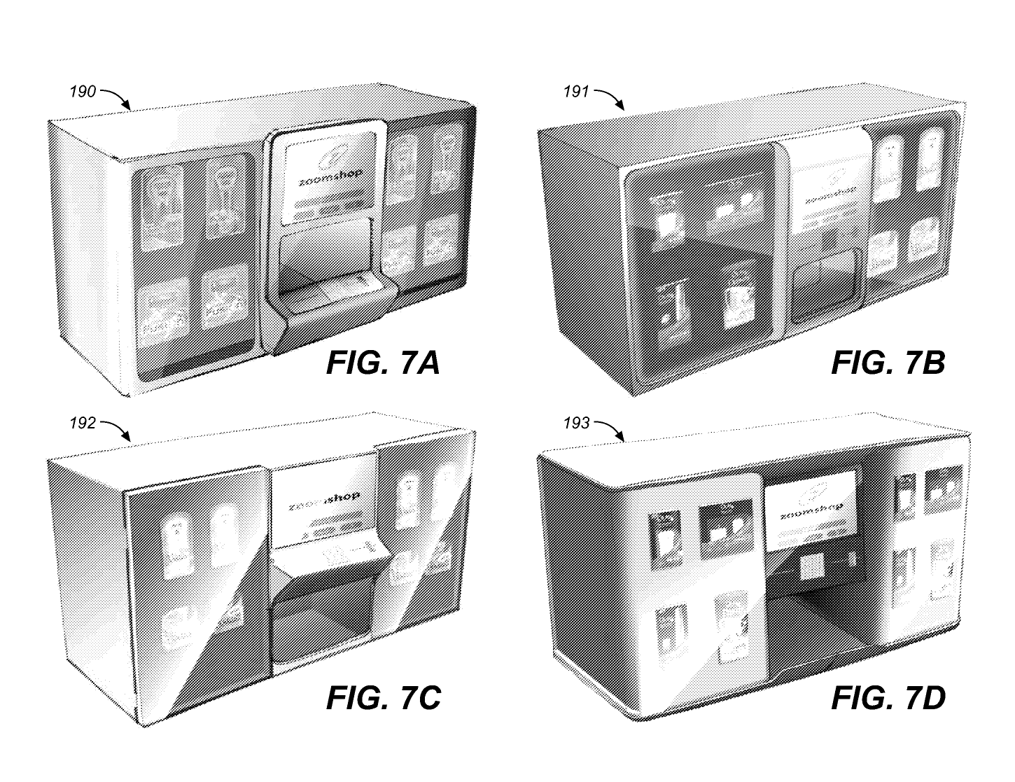

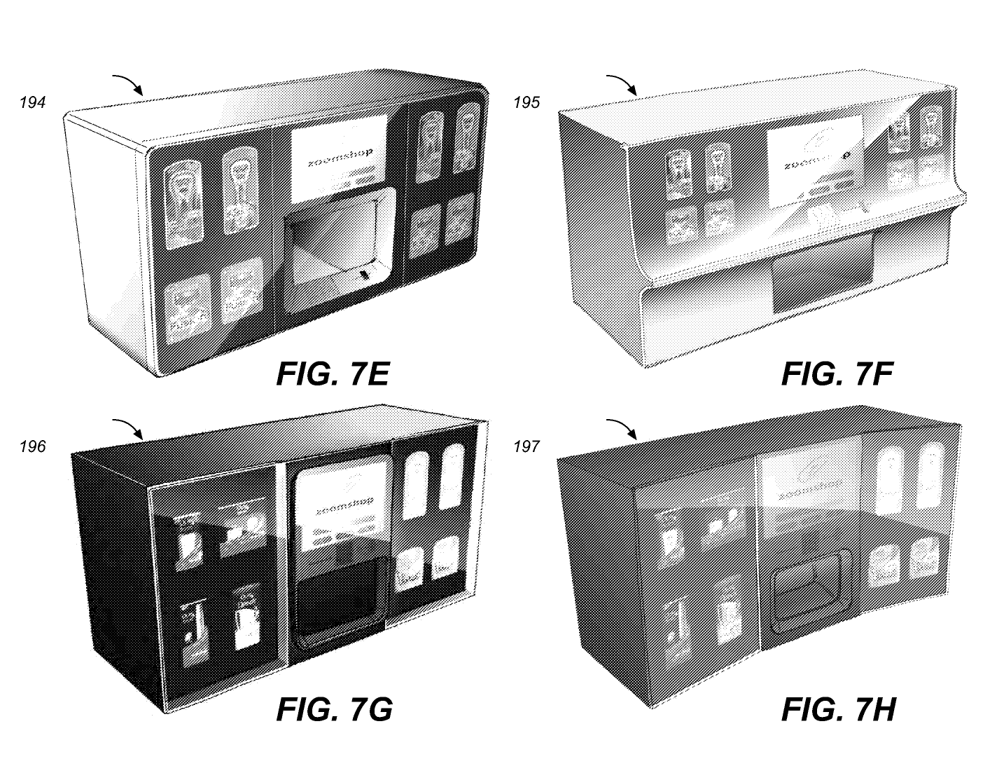

As shown in FIG. 2, various input and output devices are provided on UI section. Other control components, such as a hard drive, a central processing unit (CPU), and connectivity interfaces may be positioned in one of product storage compartments 104. In the displayed embodiment, UI section 102 includes a computer screen 110, which may be a touch screen (e.g., 15″ LCD or light emitting diode (LED) screen). Computer screen 110 may also be referred to as a screen UI or as a display for a graphical user interface (GUI). Computer screen 110 is typically positioned above other components of UI section 102 because it can be positioned at or near the eye level of an average customer. By comparison, other components may be positioned at or near the hand level of an average customer. Other arrangements are possible as well. In general, components of UI section 102 may be conceptually divided into a screen area, a physical interface area, and a product delivery area. Various respective locations of these areas are shown in FIGS. 6A and 6B as well as FIGS. 7A-7H. In certain embodiments, the screen area is positioned above the two other areas. FIG. 6A illustrates an example in which the physical interface area is positioned above the product delivery area. FIG. 6B illustrates another example in which the physical interface area is positioned below the product delivery area. The physical interface devices may be positioned at an angle to the front side of the ARS unit to provide easier access as shown in FIG. 6B.

Returning to FIG. 2, UI section 102 may also include a card acceptor 112, a keypad 114, and a printer 116. These devices may be collectively referred to as a physical interface area. Card acceptor 112 is configured to collect information from various types of cards equipped, for example, with magnetics strips, Radio Frequency Identification (RFID) chips, and other information carrying features. Some examples of such cards include credit cards, debit cards, gift cards, smart card chips, and loyalty program cards. Keypad 114 may be used to input information during payment transactions or other operations. For example, customers may use keypad 114 to enter their zip codes when prompted to do so by ARS unit 100 or, more specifically, by a message appearing on computer screen 110. Printer 116 may be used to print sale receipts, coupons, product information, and other types of information. UI section 102 may also include various video inputs (e.g., a camera), audio inputs (e.g., a microphone for communicating with a customer service representative and/or to provide voice commands to ARS unit 100), audio outputs (e.g., speakers or a jack for connecting headphones), interfaces for visually impaired customers, data ports, capabilities for wireless communication, and card dispensers.

UI section 102 also includes a product retrieval window 120, which is a part of a product delivery area in the description above. Product retrieval window 120 may be connected to a chute for delivering products from product bins to the window. In certain embodiments, product retrieval port 120 includes a ramp for sliding products towards the front of ASR unit 100. The ramp may be angled at between about 10° and 45°, for example at about 20°, to the horizontal plane. Furthermore, product retrieval port 120 may be configured to prevent customers from being able to reach product bins inside product storage compartments 104. For example, product delivery bin 120 may have a narrow opening that is sufficient for products to slide through but too small for a hand to go through and reach the product bins. In certain embodiments, the opening is less than about 3 inches in at least one dimension or, more specifically, less than about 2 inches in at least one dimension. In certain embodiments, product retrieval port 120 may have a door to prevent access to the bin in certain situations. Product retrieval port 120 may be equipped with an indicator light, for example, an LED light positioned next to product retrieval port 120 or above the window to indicate that a product item has been delivered to the window and is ready for retrieval by a customer.

In certain embodiments, UI section 102 has a barcode reader 122, which may be positioned inside product retrieval port 120, for example. Bar code reader 122 may be configured to scan various types of barcodes, such as linear bar codes and two-dimensional barcodes. Barcode reader 122 may be used by customers to validate coupons, confirm product information (e.g., scan Universal Product Codes (UPCs)), and for other purposes. UI section 102 may be equipped with other types of scanners and readers, such as an RFID reader for identifying tags of various types (Microwave, Ultra High Frequency, High Frequency, Low Frequency, etc.) and data formats. Product retrieval port 120 may be equipped with one or more sensors configured to detect the dispensing of product items into the window and the retrieval of product items from the window. In certain embodiments, these sensors are capable of identifying specific product items and differentiating between different product items available from ARS unit 100. Various types of sensors are described in U.S. Pat. No. 6,758,370, entitled “PRODUCT VENDING,” issued on Jul. 6, 2004, (Attorney Docket No. ZOOMP001US) and U.S. patent application Ser. No. 12/603,809, entitled “VENDING STORE INVENTORY MANAGEMENT AND REPORTING SYSTEM,” filed on Oct. 22, 2008, (Attorney Docket No. ZOOMP003US), both of which are incorporated herein by reference in their entireties for purposes of describing sensors.

ARS unit 100 may be configured to communicate information collected by sensors (in product retrieval port 120 and other places) to other components of the ARS system and/or external components, such as payment switches, data center, restocking services, and others. For example, information about dispensed product item may be used to credit or debit a customer's account.

Various examples of ARS unit exterior configurations are presented in FIG. 7A-7H. FIG. 7A is a schematic representation of an ARS unit 190 that has an angled physical interface sticking outside of the front face. It may also include profile ambient lighting. FIG. 7B is a schematic representation of an ARS unit 191 that has a protruding physical interface and user interface areas and may include illuminated display cases. FIG. 7C is a schematic representation of an ARS unit 192 that is shaped like a kitchen hood (with an angled physical interface sticking outside of the front face). FIG. 7D is a schematic representation of another ARS unit 193 that has a ramp for product delivery without any protective door. A small lip catches product items at the edge of the retrieval area. This design also has a recessed UI area in order to feel more private. FIG. 7E is a schematic representation of an ARS unit 194 that has a large “seamless” front and may have an illuminated product retrieval window. The physical interface components may be positioned at an angle under the product retrieval window. FIG. 7F is a schematic representation of an ARS unit 195 that has a ledge extending across the entire unit, which includes a physical interface. FIG. 7G is a schematic representation of an ARS unit 196 that has a “floating” UI island and profile illumination as well as a recessed door. Finally, FIG. 7H is a schematic representation of an ARS unit 197 that includes display cases that are angled towards a user and a “seamless” window front. Any one or various combinations of the above features may be implemented in an ARS unit.

ARS unit 100 is designed to be positioned and supported by conventional retail shelf components (e.g., shelf posts). Specifically, ARS unit 100 is designed to be installed in an aisle on standard gondola-type shelves. Some considerations for such installation positions include the overall dimensions of ARS unit 100, vertical positions of different interface areas, maximum number of different product items (e.g., SKUs), and an overall volume of product items available. For example, ARS unit 100 may be installed on a gondola in the health and beauty aisle in a grocery outlet or other similar retail environment. A typical width of shelving modules in such outlets is 48 inches, and ARS unit 100 may be designed to fit within one such module. Specifically, ARS unit 100 may need to be slightly shorter than 48 inches to avoid fit issues with neighboring shelves. For example, the width of the unit may be about 47.75 inches (1213 mm). The depth of the unit may be about 18 inches. This is the typical depth of a shelf in the health and beauty aisle. The height may be about 24 inches or some other dimension.

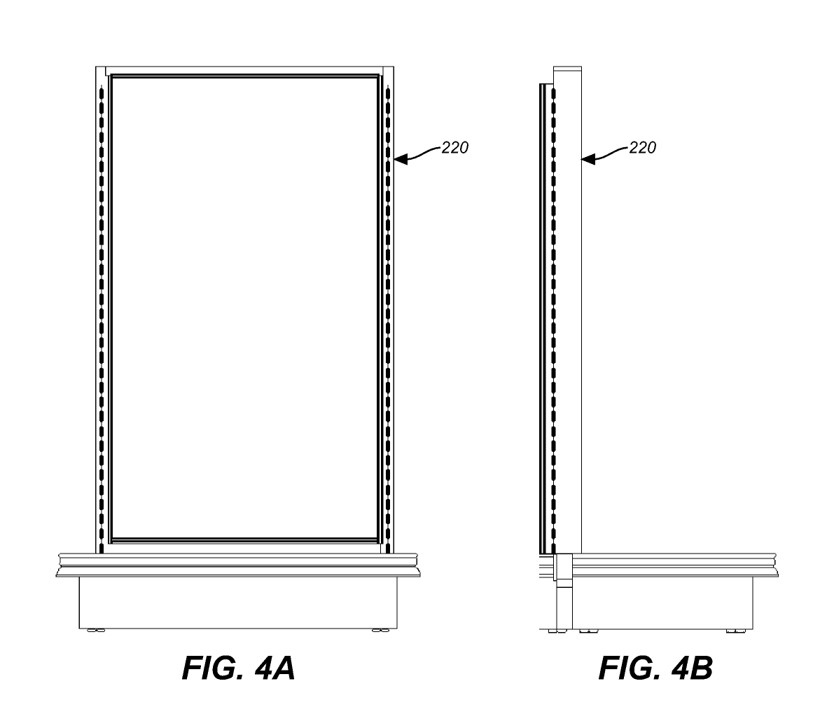

Currently, there are two main manufacturers of the shelving equipment for retail applications, Lozier in Omaha, Nebr. and Madix available from E System Sales, Inc. in Castaic, Calif. The slots for hooks on shelves that interface to the back side of ARS unit 100 are slightly different between Madix and Lozier. In certain embodiments, ARS unit 100 is equipped with a universal set of hooks. In other embodiments, ARS unit 100 is equipped with replaceable (e.g., modular) hooks. Furthermore, an intermediate adapter may be provided that may allow attaching ARS unit 100 to different types of shelf equipment (even to different widths of shelves). Some shelving dimensions for these manufacturers are presented in the table below. ARS unit 100 may be adapted to hang on any of these shelves. FIGS. 4A and 4B are schematic front and side views of a retail shelf unit for supporting ARS units, in accordance with certain embodiments. For example, shelves available from Madix have a base height above the floor of 5.5 inches. Their nominal base depth may be 12 inches, 18 inches, or 24 inches. The shelf depth varies from 12 inches to 30 inches with an increment of 2 inches. The shelf height varies from 54 inches to 96 inches with an increment of 6 inches. The shelf width varies from 24 inches to 48 inches with an increment of 6 inches; however, it also includes a 40 inch size. Among these shelves, a shelf having an 18 inch base depth, 16 inch shelf depth, 72 inch height, and 48 inch width is the most common in the health and beauty sections. Lozier manufactures slightly different size shelves, such as a nominal base depth varying from 13 inches to 31 inches with an increment of 3 inches, shelf depth varying from 7 inches to 31 inches with an increment of 3 inches (also includes 17 inch deep shelf). The shelf height varies from 54 inches to 96 inches with an increment of 6 inches. These shelves are available in widths of 36 inches and 48 inches. Among these shelves, a shelf having a 19 inch base depth, 17 inch shelf depth, 72 inch height, and 48 inch width is the most common in the health and beauty sections.

Another consideration for positioning ARS unit 100 on a set of shelf posts is the weight distribution of ARS unit 100. When two attachment mechanisms positioned on different edges of ARS unit 100 are used, the weight load should be balanced to some degree. This is a reason for positioning a UI section 102 in the middle between two product storage compartments 104. In certain embodiments, a ratio of the total weight applied to each of the two attachment mechanisms should be between about 40% and 60% at any time during operation.

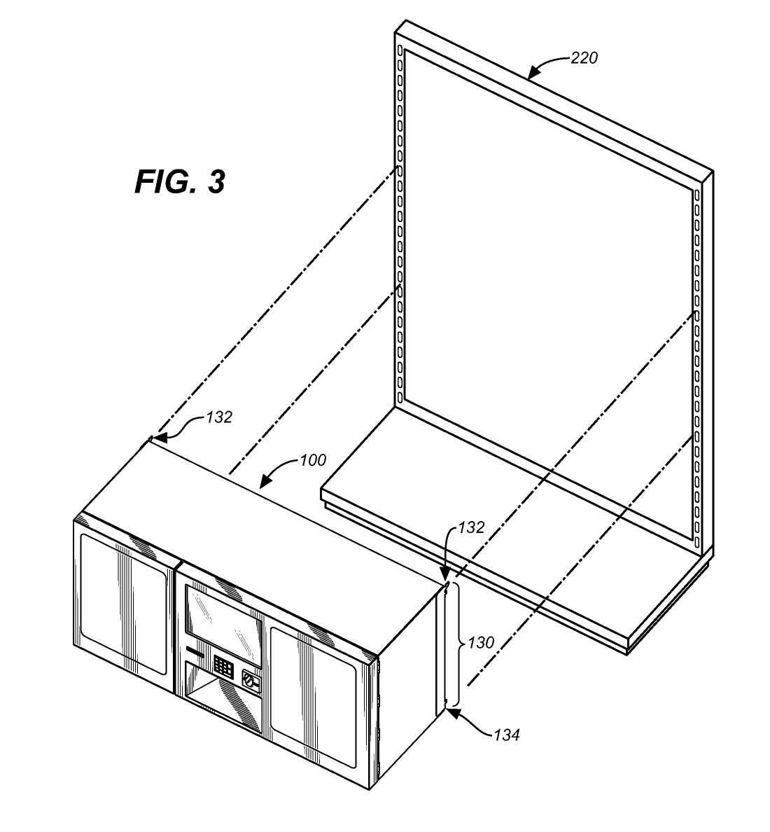

FIG. 3 is a schematic perspective view of an ARS unit 100 showing a support feature 130 provided on the back side of the ARS unit 100, in accordance with certain embodiments. Another similar support may be positioned along the opposite edge of the back side. As shown in FIG. 3, support feature 130 may include a top attachment portion 132 and a bottom attachment portion 134. One or both attachment portions may have one or more hooks for insertions into post slots of the retail shelf.

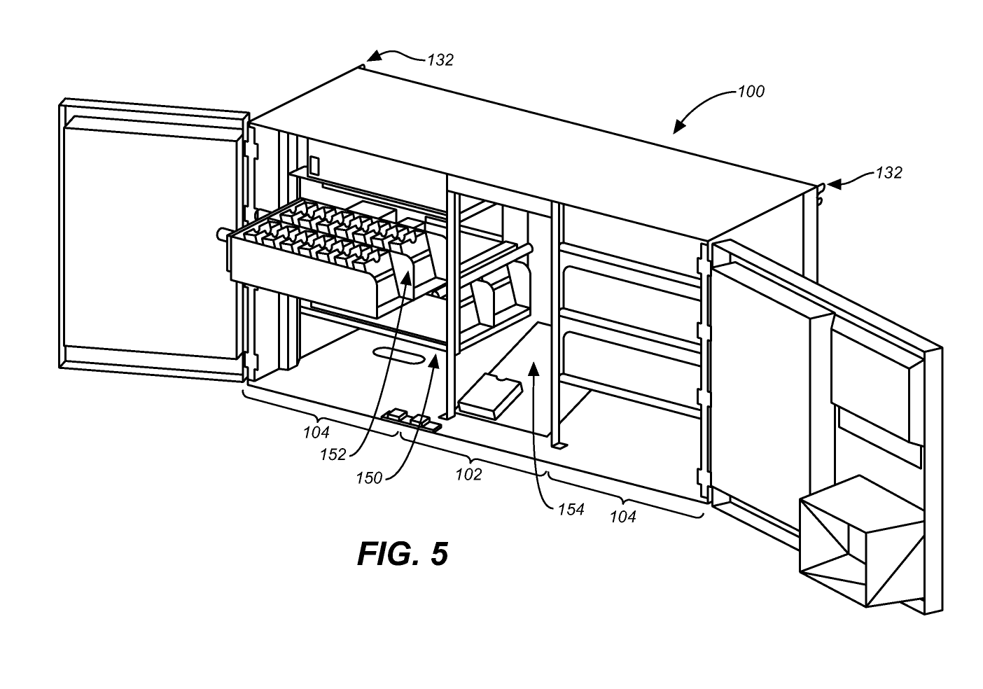

FIG. 5 is a schematic perspective view of an ARS unit 100 with access doors opened illustrating various internal features of the ARS unit 100, in accordance with certain embodiments. Specifically, the left access door is used to close left product storage compartment 104, while the access right door is used to close both right product storage compartment 104 and UI section 102. Each product storage compartment 104 includes one or more shelves 150 for supporting product items (e.g., three shelves are shown in FIG. 5 in each product storage compartment 104). Shelves 150 may be adjusted vertically and aligned to accommodate products having various dimensions. For example, the spacing between two shelves can be between about 3 inches and 15 inches or, more specifically, between about 5 inches and 9 inches. In certain embodiments, each shelf may be adjusted in increments of between about 0.5 inches and 2 inches.

Each shelf is divided into multiple product bins by dividers 152. As shown, each shelf has two product bins, but any number of bins can be used. Furthermore, each shelf may have a different number of product bins. Each product bin may stock different types of products (e.g., different SKUs). Information about each product bin is provided to the control system. This information may be updated during stocking and as products are dispensed to customers. In general, ARS unit 100 is highly configurable to store and dispense different kinds of products. Configurability is defined as a degree to which ARS unit 100 can be modified to dispense new and different product types or update assortments. The product mix may be different among different ARS units in a retail environment and even within the same ARS unit after replenishment. The ability to provide a new product mix should permit quick and easy updating, keeping in mind that SKU changes may involve changes in package size, weight, or shape. The product mix in each ARS unit is defined by a planogram, which is a physical layout of the products within the unit. The data corresponding to planogram is stored within the controller of the ARS unit and, in certain embodiments, within various external databases (e.g., a data center).

Various dispensing mechanisms may be used for transferring product items from their respective product bins and into the product delivery window. Some examples include a spiral wire displacement and vertical product chutes described in U.S. Pat. No. 6,758,370, which is incorporated herein by the reference in its entirety for the purposes of describing dispensing mechanisms. Other examples include carousel systems, vacuum systems, and dispensing systems without moving parts. Specifically, each product bin may have a dedicated dispensing mechanism for dispensing one product item at a time to a product delivery chute 154.

In specific embodiments, each product bin has a spiral wire attached to a corresponding drive motor. All motors may be controlled by a central controller, such as a computer system. In certain embodiments, the controller can drive motors at variable speeds, which allows for velocity-based dispensing profiles to be developed in order to potentially increase vending reliability. Furthermore, a controller may be used to detect the presence or absence of a motor to allow the ARS unit to automatically configure itself and/or to determine if it is misconfigured, such as to allow a technician to correctly configure the unit. Finally, the controller can measure motor torque, which allows monitoring motor health, allows us to stop a vend if an error condition is detected (e.g., jammed product), and potentially allows monitoring the progress of the vend and see when the product has fallen off the end of the coil.

After a customer selects and pays for a product item, the control system sends a signal to the corresponding dispensing mechanism. The dispensing mechanism pushes the selected product item towards the product retrieval window, which in this example is an opening in the right access door.

ARS 100 may automatically keep inventory by decrementing dispensed product items from the initial inventory, which may be entered into the control system by stocking personnel. In other embodiments, ARS 100 or, more specifically its product storage compartments 104, includes sensors for automatic determination of inventory inside product storage compartments 104. As examples, mechanical, optical, electromagnetic, and other conventional types of sensors may be used. In certain embodiments, each product item may have its own unique product identifier, such as an RFID tag.

### Computer and Computer Network Features of the ARS

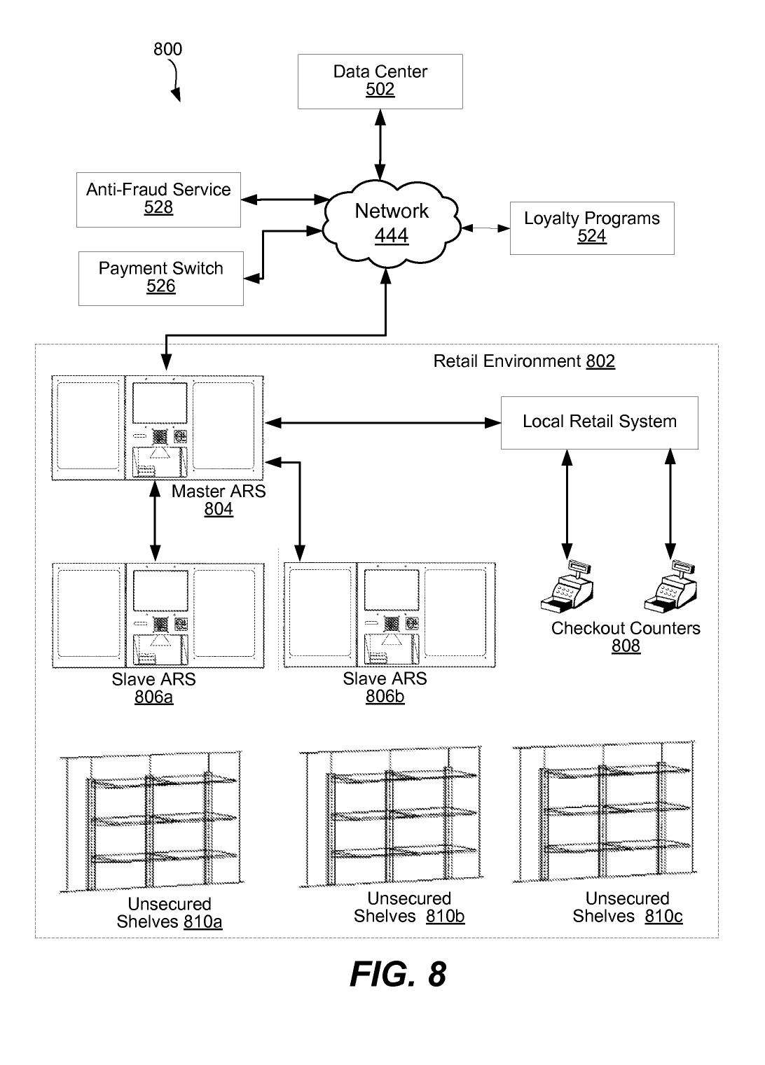

FIG. 8 is a block diagram of a network system 800 illustrating various communication links within the system, in accordance with various embodiments. Retail environment 802 may include one or more ARS units 804, 806a, and 806b for secure storage of product items, checkout counters 808, and unsecured shelves 810a, 810b, and 810c for unsecure storage of product items. ARS units 804, 806a, and 806b allow customers to purchase securely stored product items without a need for further transactions at checkout counters 808. In certain embodiments, ARS units 804, 806a, and 806b may allow customers to purchase product stored on unsecured shelves 810a, 810b, and 810c without a need for further transactions at checkout counters 808. In this later example, ARS units 804, 806a, and 806b act as a self-checkout counter. Furthermore, ARS units 804, 806a, and 806b may issue coupons or other identification slips for presenting at checkout counters 808 and processing at that location.

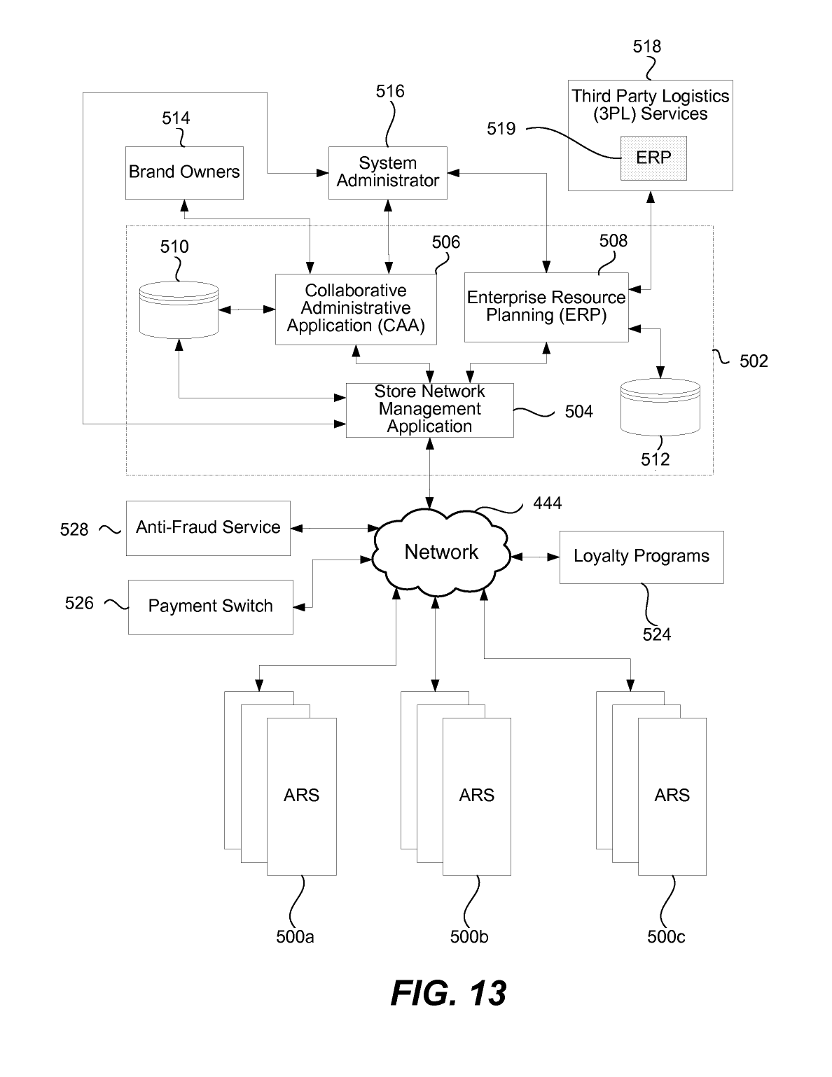

An ARS unit may connect through one or more networks to other ARS units and/or a central control system, which may be internal to the retail environment, such as a local retail computer system, or external to the environment, such as a remote data center, an anti-fraud service, a payment switch, or a loyalty program site. Various features associated with the data center are described below with reference to FIG. 13. Not all ARS units in one system may have the same functionality and collection of hardware and software components. Some ARS units may be more functional than other ARS units. For example, one ARS unit 804 (i.e., a “master”) may have more advanced hardware and software that allows this unit to connect to other ARS units 806a and 806b (i.e., “slaves”) as well as to outside networks (e.g., network 444) and systems (e.g., data center 502, anti-fraud service 528, payment switch 526, loyalty programs 524). These outside networks and systems are described below with reference to FIG. 13. Slave ARS units 806a and 806b may be able to connect only to master ARS unit 804 as shown in FIG. 8. In other words, master ARS unit 804 may be the principal point of contact for communication with data center 502 and/or other systems. In such embodiments, master ARS unit 804 unit may receive updated content from these systems for subsequent distribution to slave ARS units 806a and 806b. Master ARS unit 804 may collect and store data from slave ARS units 806a and 806b, for example, by periodically polling slave ARS units 806a and 806b for updated information about sales, inventory, customer interactions, and the like. Master ARS unit 804 may direct, at a high level, various operations of slave ARS units 806a and 806b. In a similar manner, master ARS unit 804 may be a principal point of contact with internal systems of retail environment 802, such as checkout counters 808.

This master/slave configuration may provide substantial savings with respect to software and hardware costs of the overall ARS system. Specifically, slave ARS units may be equipped with “bare-bones” computer systems that allow for supporting the user interface, dispensing product items, and communicating with a master ARS unit. All complex processing and external communications are provided at the master ARS unit with more sophisticated software and hardware.

In certain embodiments, content on computer screen 110 of the slave unit is only rendered by the local computer's browser, while this content is generated and provided to the slave unit by the master unit. Examples of content include product information, advertisements, help menus, and the like. Additionally, all payment processing and other complex processing logic and functions may be completed by the master unit's computer instead of the slave unit's computer. The slave unit may be responsible for relatively simple logic and functions, such as computer screen rendering and controlling dispensing. As such, the slave unit's computer can be much more simple (e.g., less processing speed, memory), have a smaller physical footprint allowing more space inside the unit for storing products, and may generate less heat.

In the same or other embodiments, a master-slave scheme may be used to complete single coordinated transactions to provide additional benefits to customers. For example, a customer may select two or more product items for purchasing. These product items may be stored in one or more units configured according to the master-slave scheme. The customer may use one unit for selection and payment, for example, and a different unit for collecting some of these product items. In certain embodiments, a customer may use multiple machines to collect different product items. Customers may be incentivized to complete this multi-item purchase through coordinated discounts related to buying multiple product items. Additionally, mechanisms such as access codes, bar codes, or re-swiping payment cards could be used to trigger dispensing of previously purchased product items from other units (i.e., the units that contain the purchased product items but that have not been used by the customer for selection and payment). In certain embodiments, this master-slave scheme may also include an internal retail system. For example, a customer may pay for items at one of the traditional register lines and then proceed to a ARS unit to retrieve the product.

### Functional Features of the ARS

An ARS unit allows customers to obtain information about products available for sale at least from this unit, select one or more product items for purchase, collect and process payment information, and dispense products. Additional functions, which may be optional, include cross-selling and up-selling of products in the same retail environment, particularly unsecured products located in close proximity to the automated retail shelf. Cross-selling is generally understood to be delivering information to a customer about additional products available from the same ARS unit, other ARS units, and/or unsecured shelf locations based on information available at the ARS unit about this customer or the current product selection. The customer's information may include previous purchases made by this customer, previous product selections, loyalty club information, and other data. Up-selling is generally understood to be a specific application of cross-selling where the additional products tend to be more expensive versions of the products currently selected by the customers.

The overall ARS concept presents unique cross-selling and up-selling opportunities based on the physical proximity of ARS units to other, unsecured product items within the same retail environment. This proximity, coupled with an automated approach of ARS units, amplifies the value of cross-selling and up-selling in such environments and presents marketing and business opportunities previously not available to the retailers. Some of these opportunities are presented in the following examples.

In certain embodiments, an ARS unit is positioned in a diverse retail environment, such as a convenience store or a grocery store. The ARS unit may be stocked with only one type of product (e.g., razor blades). As explained above, razor blades are small, high-valued items that are very susceptible to theft. The ARS unit may be positioned among other complementary products that are less susceptible to theft, such as shaving creams and shaving lotions. Not only are these complementary products now positioned in the same physical retail location without an increased risk of product theft or occupying premium secure retail locations, but such strategic positioning allows using the ARS unit to remind customers about other nearby products, provide information about these products, and direct customers to their locations. Of course, the ARS unit may also direct customers to other products available for sale from this or other ARS units. For example, a customer may select a pack of four razor blades using the user interface of the ARS unit. The same user interface may then inform the customer about other available products (e.g., eight razor blade packs, sixteen razor blade packs, etc). The user interface may also inform about particular benefits associated with purchasing these other products (e.g., a lower price-per-blade, new design or product features, etc). The ARS unit may issue an instant coupon or discount for these other products based on information now available to the ARS about this customer, such as customer's loyalty club membership, and previous product selections (or, more generally, click patterns). The coupon does not need to be previously available to this or other customers before a particular product selection was made. This coupon issuance process may be considered a “dynamic” process because it accounts for recently collected information about this particular consumer. Of course, a more traditional marketing campaign may be implemented on ARS units and systems as well, which may be referred to as “static.”

Upon completing the sale and dispensing the purchased product items, the ARS unit may inform the customer about other complementary items, such as shaving creams and shaving lotions, which may be available from unsecured shelves or other ARS units. The ARS unit may issue a coupon or some other form of discount, which may also be “dynamic” and/or “static.” For example, a coupon may be printed together with the sale receipt or offered for printing through a user interface. In certain embodiments, an ARS unit may send a coupon via an e-mail or Short Message Service (SMS), Multimedia Message Service (MMS), Text Message Service (TMS), or other message-protocol message to the customer based on the information collected from this customer by the ARS system. For example, the customer may have previously entered his loyalty club information, which in turn may be used to retrieve the customer's e-mail and/or cell phone information. In the same or other embodiments, an ARS may prompt the customer to enter e-mail and/or cell phone information on a user interface. Therefore, the coupon may be delivered to the customer's devices, such as his cell phone, while the customer is still within the same retail environment. In certain embodiments, the coupon information may be sent to the checkout register without a need for the customer's involvement, such as obtaining a paper slip or retrieving an e-mail or SMS message (or other types of messages) on the cell phone. In other words, the retailer's central control system is notified by the ARS about all coupons and discounts associated with this customer.

In certain embodiments, an ARS system is used to deliver various product and retail environment information to customers, such as the location of various complementary and other products. In other words, the ARS system may be an informational kiosk such that a customer does not need to look for a retail clerk if he needs to find his way around the retail environment. This information may be delivered on a user interface of the ARS unit, printed in a receipt-like format, sent to the customer's device (e.g., to a cell phone via SMS. MMS, TMS, e-mail, or some other medium/interface).

In certain embodiments, cross-selling and up-selling is facilitated through a direct network communication protocol between an ARS unit and the local retail system. The local retail system may have detailed information about products available in the entire retail environment, such as unsecured shelves. The information may include current inventory of products, pricing, location, and product information. FIG. 8 illustrates a communication link between the master ARS unit and local retail system, which may be used to transfer such information. Additionally, the local retail system may collect information from various ARS units about their respective sales as well as their sensors' data.

ARS units may also be used by customers to purchase product items that have been obtained by the customers from other locations in the retail environment (e.g., picked up from an unsecured shelf). For example, a customer may have a few product items in his shopping cart that he has not paid for when he approaches an ARS unit. Instead of going through a conventional checkout counter to pay for these items, the customer may use the ARS to complete this transaction. This sale may be conducted in addition to or instead of purchasing an item from this ARS unit (i.e., the item stored in the ARS). Specifically, a barcode scanner of the ARS unit may be used by the customer to identify the items in his shopping cart by, for example, scanning their UPC barcodes. Additional functionality for identifying specific product items may be provided through the user interface, such as locating an item in a catalog associated with this retail environment. The ARS units may be equipped with certain security features to prevent product items being stolen during this sale transaction, such as weighing scales for placing items after scanning in the ARS unit, video cameras, and so forth. Upon completing this transaction, the ARS unit may issue a receipt, which can be then presented by the customer when he or she exists the retail environment (e.g., goes out of the doors of the retail outlet).

In certain embodiments, an ARS unit is able to collect and, to a certain degree, analyze various data points corresponding to customer interactions with the ARS unit as well as data representing some aspect of the retail environment. For example, an ARS unit may be configured to capture and analyze click-steam/click-pattern data, inventory data, and sales data. Furthermore, the ARS unit may be equipped with one or more sensors for collecting information about customers. For example, the ARS unit may be equipped with a traffic counter, a video camera capturing customers' images (and analyzing these images for various demographic information), or other types of sensors further described below. This information may be useful to the retailers.

ARS units may also be used by consumers to learn about products that are located on the shelves and, in certain embodiments, to receive coupons for these products. For example, a customer may scan a barcode on the shaving gel can using a barcode reader of the ARS unit that sells items other than shaving gel cans (e.g., razor blades). The computer screen of this unit would then display certain product education materials pertaining to this shaving cream and offer a coupon to this customer. That coupon could then be then printed using a printer of the unit or delivered electronically using e-mail or SMS, MMS, TMS, or other message-protocol message. In this example, the customer benefits from the discount, while the retailer (or brand owner, operator of the ARS unit) is capable of obtaining additional information from customers.

### Definitions

The term “product information” refers to any information that relates to a particular product item or a group of items, such as product images, pricing, description, availability, inventory, advertisement, and promotions. Selected product information that has been organized in a particular format suitable for presentation on user interfaces of ARS units is sometimes referred to as “product presentation.” A product presentation may take a form of a product page, a catalog page, or an advertisement. Product presentations sometimes refer to other information presented on the user interface of an ARS unit such as a welcome screen, help menus, and purchasing transaction screens that may not directly relate to a particular product or contain product information.

The term “template” refers to a specific configuration that is preset and available to selected users for creating product presentations. The template may have certain fields defined in such a way that no further updates or integration is necessary prior to uploading the files containing the presentations created from the templates to the ARS units.

The term “product” (sometimes stated as “product item”) refers to an actual physical item stored in an ARS unit and generally available for purchase and dispensing. For example, an ARS unit may stock several digital cameras having the same brand and model number. Each of these cameras is a separate and distinct “product.” In certain contexts, products made available via an ARS unit include “non-physical” products, such as warranties, service plans, loyalty club memberships, media files, and other services and offerings. In these contexts, an ARS unit may not need to use an automated dispensing mechanism to provide products to customers.

The term “product type” refers to a category or class of products, such that multiple product items may share the same product type. Generally, a product type may reference a specific model or any level of product category (e.g., digital cameras, single lens reflex (SLR) digital cameras, 10 megapixels SLR digital cameras, etc.) Various brands of products may fall under the same product type. Divisions between product types may be defined in a hierarchy or other ontology.

The term “user interface” (also “customer interface”) refers to a combination of hardware and software that typically includes a display for viewing product presentation content and other content such as inventory content and maintenance content for supply and maintenance personnel, respectively. A user interface typically includes functionality for providing input and navigating among multiple types of information and options provided by the user interface. The user interface may be configured to execute HyperText Markup Language (HTML), Extensible Markup Language (XML), Java and other commands embedded into files corresponding to product presentations and other features and functions of ARS units. In certain embodiments, a user interface may include a touch screen and a browser. The browser receives information from a web-server (running either locally within the store or remotely over the data network) and a main program and displays it on the touch screen. A customer may select various displayed options by touching the respective areas of the screen, which triggers various commands for execution by the web-server and the main program.

The term “brand owner” refers to an entity having products available for purchase in one or more ARS units. In certain embodiments, a brand owner has exclusive or shared control over the content of product presentations pertaining to the brand owner's products. In some cases, a brand owner may be a retailer renting ARS units. Such retailer may define and control product presentations displayed on the rented ARS units. The retailer may share this control with a marketing entity and other entities. The level of control may vary among different entities. An ARS unit operator may also have some or full control over product presentations to ensure compatibility with ARS unit configurations.

The term “sales data” refers to information pertaining to one or more purchases from an ARS unit. This information may include, for example, time stamps identifying the timing of various transactions, identification of ARS units where sales took place, lists of products purchased and corresponding prices, methods of payment, personal information about purchasers, membership affiliations, products reviewed but not purchased, and/or product dispensing problems. Sales data may be communicated by a corresponding ARS unit after each purchase or may be pooled and subsequently uploaded during predetermined communication sessions.

The term “customer interaction data” refers to information pertaining to any interaction of a customer with an ARS unit that an ARS unit is capable of detecting. For example, an ARS unit may count a number of times a customer touched its touch screen. Relevant detection mechanisms in the ARS units include not only computer user interfaces such as touch screens but also various types of sensors. For example, sensors may be configured to detect a customer's presence in certain areas around the store, detect a customer's interest in particular products, count foot traffic near the store, and collect any other data that may be of interest to brand owners, ARS unit management entity, or any other party. Examples of sophisticated customer interaction data include conversion and abandonment rates. Some types of customer interaction data qualify as sales data as well.

A “customer parameter” is defined as any characteristics that can be attributed to the customer and detected by an ARS unit sensor or identified in some other way (e.g., retrieve from the information handled by the ARS unit, such as payment information, information stored in the data center, etc.). Examples of customer parameters include, but are not limited to, various demographic information (e.g., age, gender, nationality), house hold income, identification and contact information (e.g., name, address, e-mail, telephone number), shopping transaction information (e.g., user interface inputs), payment information, actions in the proximity of the store (e.g., viewing certain product items, approaching various parts of the store, proximity to the store), and environmental and situational information (e.g., time of day, nearby traffic, noise level, etc.).

The term “inventory data” refers to information on all or a subset of the product items that are present in an ARS unit at any given time, such as the time when the inventory was stocked or after a certain type of purchase was made, for example. Examples of inventory data include times when inventory was stocked, product identifications (SKU, etc) and corresponding quantities, arrangements of products inside an ARS unit (e.g., mapping product items to product compartments), and/or previous or scheduled replenishing events.

### Electrical Hardware

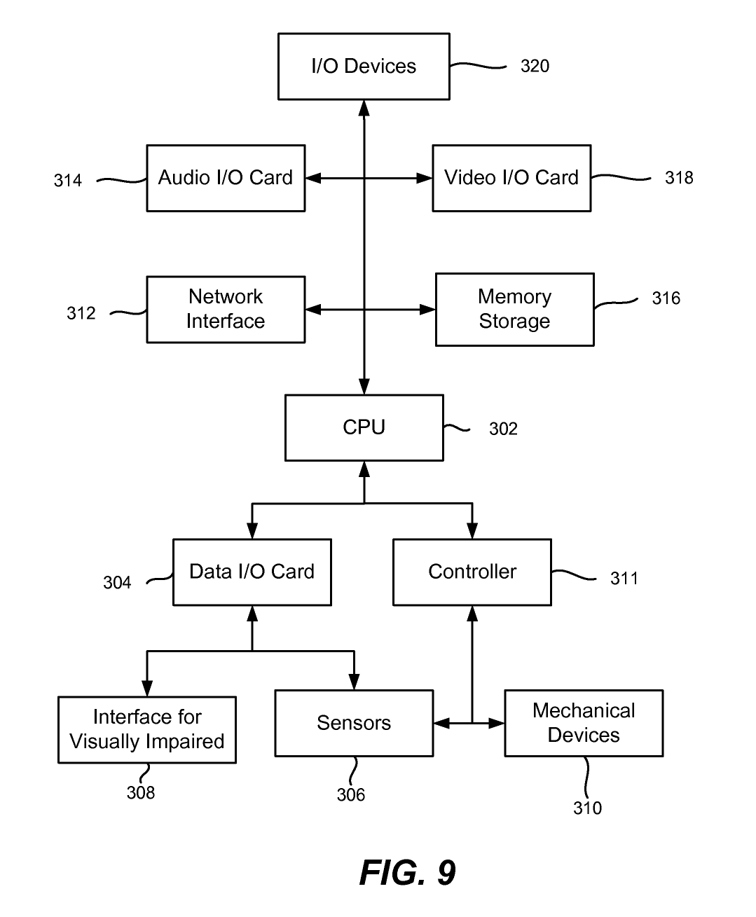

FIG. 9 illustrates a computational hardware arrangement and associated interconnections within an ARS unit, in accordance with certain embodiments. Some of the components may be included in a computer, a controller, or other combination of elements interconnected amongst each other. A computer, one or more controllers, microprocessors, and/or other hardware processing elements may be configured to run software, as further described below. For example, a computer may include an operating system (e.g., Windows XP), a browser (e.g., Internet Explorer), a web-server (e.g., Tomcat), application software, controller software, and other components. Additionally, the ARS unit processing apparatus described here may serve to control any one or more of the various ARS unit functions described above.

In the depicted embodiment, a CPU 302 is connected to a data Input/Output (I/O) card 304. The card in turn may interface, via a serial connection or other type of connection, with one or more sensors 306 and a visually impaired (VI) interface 308 for the visually impaired. Additionally, the CPU 302 is connected to a controller block 311 for interacting with mechanical devices 310, such as motors, actuators, valves, and other mechanical hardware components, which could be done through a serial connection port. In some embodiments, the controller block 311 represents multiple controllers, each configured to execute its own specific control algorithm(s), which may be encoded in software, firmware, combinations thereof, and so forth. In certain embodiments, the controller block 311 controls the dispensing mechanism. When a customer selects and purchases a product, the CPU 302 detects a signal from the computer screen 110 and other components of the user interface and directs the dispensing mechanism 160 to deliver the product to the product port.

Various sensors 306 may be also connected to the CPU 302 through the data I/O card 304 with one or more connections, such as serial connections, Universal Serial Bus (USB) connections, single wires, pairs of wires, or other suitable interconnection. As explained, one or more proximity sensors may detect the presence of potential customers near an ARS unit.

In the depicted embodiment, the CPU 302 is also connected to the network interface 312, which may be a network card, a modem, or any other device allowing an ARS unit to interact with a network system such as the Internet or a wide area corporate network. In certain embodiments, the network interface is a Digital Subscriber Line (DSL) modem and/or high-speed cable or cellular modem. Such interface and associated communications logic may be used by the ARS unit 100 to exchange data with the data center and/or other services during a communication session (e.g., a packet switched Internet Protocol (IP) communications session). In certain embodiments, the communication portions of the ARS unit are configured to initiate communication with the data center and/or other services, although in some embodiments, they may be configured to respond to requests from external network entities.

The CPU 302 is typically connected to a memory storage unit 316, such as a non-volatile hard drive, a main memory or Random Access Memory (RAM), a Read Only Memory (ROM), or a combination of these or other memory devices suitable for use with computing systems. The memory storage unit 316 may comprise one or more of a magnetic drive, a semiconductor memory, and the like. The memory storage unit 316 may be used to store software programs, routines, scripts, and modules, as well as data such as product presentation data, transaction data, and/or sensor data.

Additionally, in the depicted embodiment, the CPU 302 controls various features of the computer screen 110 and other components of the user interface via connections to an audio I/O card 314, a video I/O card 318, and various other I/O devices 320, such as a pointing device (e.g., a mouse), a keyboard, and the like.

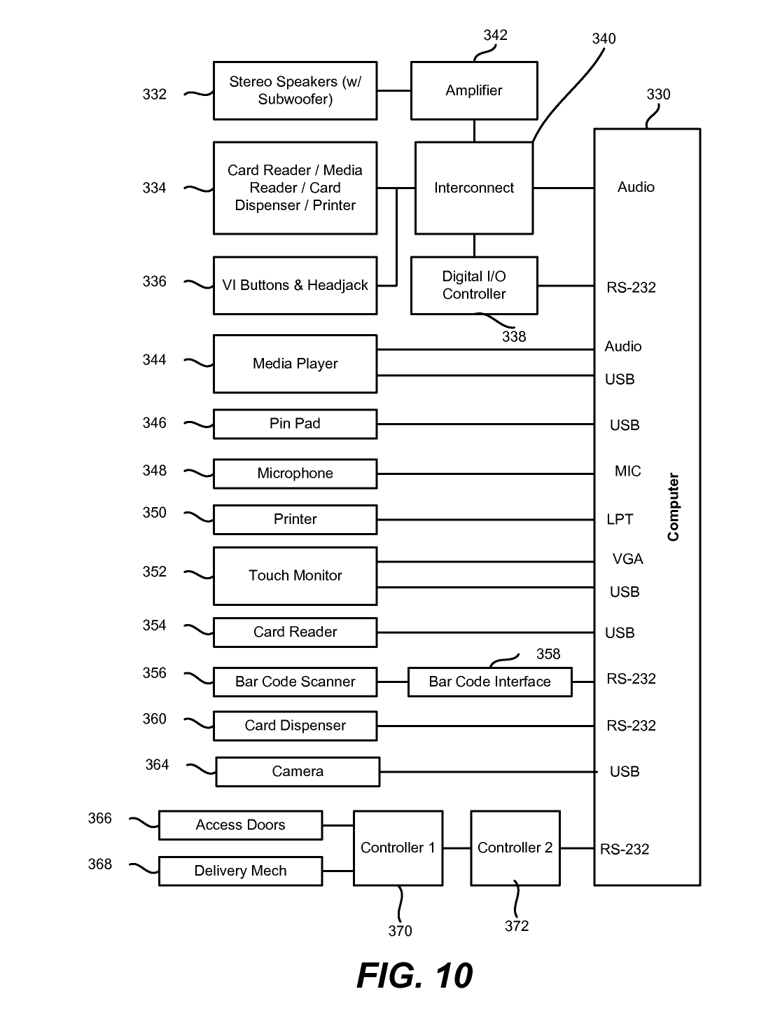

FIG. 10 is an electronic schematic diagram of an ARS unit's hardware, in accordance with certain embodiments. A computer 330 is interconnected with various devices (including various peripheral devices) in the ARS unit through a variety of different ports. As illustrated, stereo speakers 332 may be connected to an amplifier 342, which is in turn connected to an interconnect 340. Another set of devices 334, (e.g., a card reader, a media reader, a card dispenser, and a printer, in this example) may also be connected to the computer 330 through the interconnect 340. As shown, a printer 350 is directly connected to the computer 330 via an Line Print Terminal (LTP) port; while a card reader 354 is connected using a USB port. As noted, the interconnect 340 is connected to the computer 330 using an audio port. In addition, the interconnect 340 is connected to the computer 330 using a digital I/O controller 338 and an RS-232 port. A visual impaired interface 336, including a set of buttons and a headphone jack, is also connected to the computer 330 through the interconnect 340. In the depicted embodiment, a media player 344 uses both an audio port and a USB port for its connection to the computer 330. A personal identification number (PIN) pad 346 and a camera 364 are typically connected using a USB port. The computer 330 has a microphone port for connecting a microphone 348. A touch monitor 352 is connected using a Video Graphics Array (VGA) port and a USB port. Finally, a combination of a barcode scanner 356 and a barcode interface 358, a card dispenser 360, and access doors 366 in combination with a delivery mechanism 368 and a set of controllers 370 and 372 are connected to the computer 330 via RS-232 ports.

### Software

A software installed on a computer system of the ARS unit maintains the store configuration, manages the user interface, performs payment processing, and initiates product dispensing. Additionally, the software includes features for replenishment, self-diagnostics, reporting, and communication of all relevant information back to the centralized network.

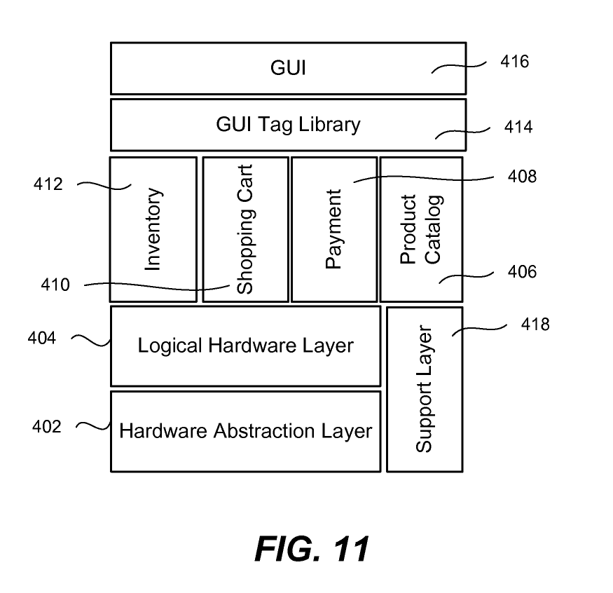

FIG. 11 is block diagram representing a multilayer architecture of the software implemented on an ARS unit, in accordance with certain embodiments. A hardware abstraction layer 402 is the base level in the software architecture and provides an interface to the physical hardware of the ARS unit described above. It provides a consistent software interface for ARS units, which may have various alternative hardware configurations. The hardware abstraction layer 402 effectively hides differences in the hardware from the operating system kernel. The next level in the depicted embodiment is a logical hardware layer 404 sitting on top of the hardware abstraction layer 402. The logical hardware layer 404 provides a framework that may exist across multiple implementations of the ARS unit business logic, and may represent such concepts as a dispenser, mapping of the dispenser to a product, a product item count in the dispenser, and operation of the dispenser. The hardware abstraction layer 402 and the logical hardware layer 404 are the support functions 418 that may be used by the business logic for communication, security, persistence, and the like. Above the hardware layer 404 and the support layer 418 (at a higher level of abstraction) resides various modules enabling customers and, in some situations, service personnel and administrators, to review product information, select a product, pay for the selected product, and manage inventory of an ARS unit. The depicted modules include a product catalog module 406, a payment module 408, a shopping cart module 410, and an inventory module 412. Each module may comprise software to perform the functions listed above. For example, the inventory module 412 may maintain current inventory data, check availability of specific products in the inventory, and change inventory data after the product been paid for and dispensed.

All modules may interact with the GUI tag library layer 414, the support layer 418, and the logical hardware layer 404. The GUI tag library layer 414 provides properties and methods of the business objects to the GUI layer 416. In this or another embodiment, the GUI layer 416 may include Java Server Pages (JSP) that use JSP tags. The specific GUIs that implement the GUI layer 416 may be different for various ARS units corresponding to different brand owners. This approach may enable an ARS unit to have a unique presentation and overall appeal. For example, the GUI layer 416 may implement the layout of information on the screen, the color scheme, logos, and any custom implementation for a particular brand, such as a product demo.

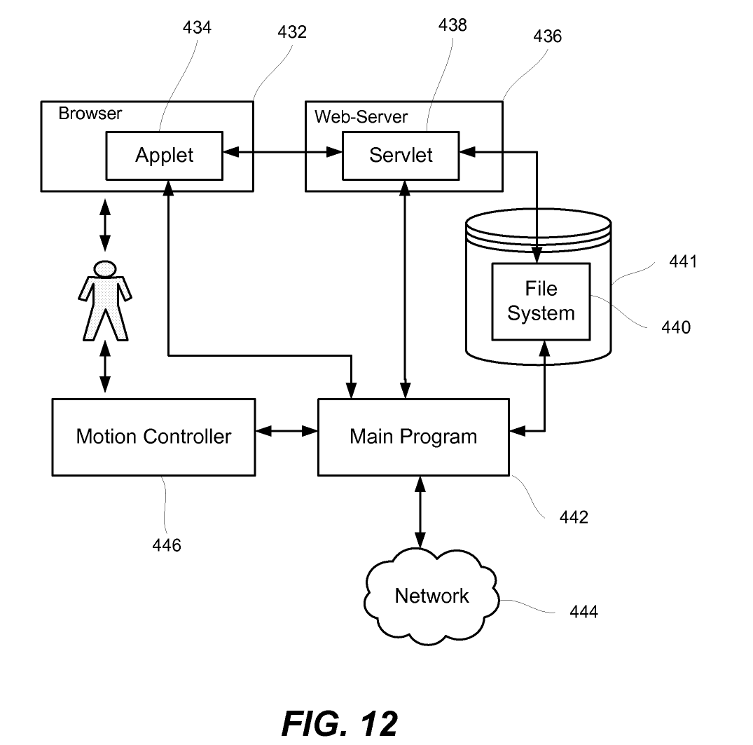

FIG. 12 is a block diagram illustrating various ARS unit components and their interrelationships, in accordance with certain embodiments. All components may be included in a single ARS unit and communicate with other elements of a product vending system through a network 444 (e.g., the Internet). Such communication may be controlled by a main program 442 running on a computer system of the ARS unit. In certain embodiments, the main program 442 is a Java application. Regardless of how it is implemented, the main program 442 may control and interact with various other software components of the ARS unit. In the depicted embodiment, for example, the main program interacts with hardware devices through a hardware controller, accesses a file system 440, and interacts with other programs, such as a servlet 438 on a web server 436 and an applet 434 on a browser 432.

The file system 440 may be a collection of data files stored on a memory storage device 441. Data files may include inventory information, transactional and activity history of an ARS unit, product presentations, sensor feedback, and other information. The main program 442 coordinates file system 440 data exchanges with the data center as described elsewhere herein. For example, the main program may include a timer or any other criteria to trigger communication with a data center.

The main program 442 may be in direct communication with a web-server 436 installed on the vending machine. Alternatively, the system may provide other user interface configurations, for example, using an operating system such as Microsoft Vista™ or other sophisticated client technologies. In certain embodiments, the web-server 436 is a Tomcat web server available from the Apache Software Foundation, in Forest Hills, Md. The web-server 436 may implement JSP. Various custom tags may be implemented that give the JSP access to the application objects described above, such as the shopping cart module 410, the payment module 408, the product catalog module 406, and the inventory module 412. In general, and regardless of the specific implementation, the web-server 436 acts as a container for a collection of servlets 438 that actually perform the web-based processing. The servlets 438 are programs that run within the web server 436 and process requests from an applet 434 running in the browser 432. The web-server 436 is responsible for accepting hypertext transfer protocol (HTTP) requests from the browser 432 and providing HTTP responses along with some data, such product information.

A customer interacts with the browser 432. In a specific embodiment, the browser is Microsoft's Internet Explorer™, Mozilla's Firefox™, or any other suitable browser. As mentioned, the browser 432 may include the applet 434, which may be, for example, implemented in Java to allow web pages to communicate with the main program 442 and the servlets 438 on the web-server 436.

The main program 442 may also communicate with the servlets 438. The primary means of communication between the servlets 438 and the main program 442 is writing to, reading from, and/or sharing files. For example, the servlets 438 may store information about a customer's shopping cart. The main program 442 may process the payment associated with this shopping card, such as communicating the amount and account information over the network 444, and then instruct the hardware controller 446 to dispense the products corresponding to the shopping card.

### Network

FIG. 13 is a block diagram of a network system including one or more ARS units, in accordance with certain embodiments. A network system includes a data center 502, which is connected through one or more networks 444 (e.g., the Internet) to a plurality of ARS units, illustrated as 500a-c (also referred to as a “ARS unit 500” in singular form). The ARS units 500a-c may be grouped based on the brands they sell. The overall network system may be configured to support different planograms, hardware peripherals, user interfaces, and so forth. It should be understood that the ARS units 500a-c on the network need not all have the same functionality. Often the ARS units 500a-c will be heterogeneous, with some ARS units having some functionalities that others lack.

The data center 502 may include an application 504 (sometimes referred to as a store network management application) for interacting with the ARS units 500a-c and managing ARS unit information. The data center 502 may also include a collaborative administrative application 506, an Enterprise Resource Planning (ERP) module 508, and at least one data store 510. It should be understood that any number of data stores 510 may be used to provide data storage for any of the applications and modules of the data center 502. For example, a designated data store 512 may be used to support the ERP 508 functions. Alternatively, a single data store 512 may serve all the needs of the entire data center 502. In certain embodiments, various physically discrete data stores 512 connect to one another via a storage area network.

Providing the store network management application 504, the collaborative administrative application 506, and the ERP 508 as logically distinct modules allows for significant flexibility and functionality of the data center 502. In the depicted embodiment, the store network management application 504 is used primarily for communication with the ARS units 500a-c and uploading new data and collecting historical data from the stores. In many embodiments, only a system administrator 516 has access to the store network management application 504. The collaborative administrative application 506 may be used by brand owners 514 to manage product catalog data and review selected data from the corresponding ARS units 500a-c. The ERP 508 manages inventory information for the ARS units 500a-c and interacts with various third party logistics (3PL) services. In some embodiments, some or all applications (i.e., store network management application 504, collaborative administrative application 506, and ERP 508) may be integrated into a single integrated application. The reasons for integration or separation of these applications may include the amount of time users spend with each application, user proficiency, network configurations (e.g., whether the users are within the vending companies networks or outside of those networks), degree of fine control needed over the configuration, collaboration requirements, needs for versioning of product presentations and data reporting, and other various factors.

While many business models can benefit from the disclosed network system, one will be emphasized herein. In this particular model, one business entity, an ARS unit management entity, which is generally represented by the system administrator 516, provides the ARS units 500a-c and maintains basic network infrastructure. It controls most functions of the data center 502 and interacts with multiple brand owners 514 and potentially multiple third party service providers, such as a payment switch 526, third party logistics services 518, anti-fraud service providers 528, loyalty programs provider 524, and the like. The brand owners 514 provide products for the ARS units 500a-c and define or help define the product presentation content for individual ARS units 500a-c that stock their products.

The store network management application 504 may be implemented on one or more servers that are configured to communicate with the ARS units 500a-c. The complexity and number of servers may depend on a number of the ARS units, store locations, the type and amount of data transferred between the stores and the servers, and other parameters. In certain embodiments, the store network management application 504 is partitioned, and the partitions are designated for particular sets of ARS units. The store network management application 504 may allow centralized configuration and monitoring of the ARS units 500a-c. For example, a brand owner 514 may select and arrange certain data or other information in the collaborative administrative application 506 (e.g., to create or modify product presentations) and propagate the information to specific sets of ARS units via the store network management application 504. The brand owner 514 may collaborate with the ARS unit management entity, such as a system administrator 516, to create and/or modify product presentations. The configured data may be stored in one or more data stores 510 of the data center 502. The store network management application 504 typically processes this data by providing additional configurations and attributes specific to the selected ARS units. For example, some ARS units may have different hardware and/or software configurations and the uploaded data may need to reflect this difference.

The collaborative administrative application 506 is an application that facilitates collaborative generation of content for ARS units 500a-c and, also the administration and reporting of the network system performance at a higher level of abstraction than that provided by the store network management application 504. The collaborative administrative application 506 may be used by both a system administrator 516 (or more generally an ARS unit management entity) and a brand owner 514, while the store network management application 504 is primarily for use by the system administrator 516. In certain embodiments, the collaborative administrative application 506 provides an interface for multiple brand owners 514 to separately manage ARS unit configuration data and view data received from the ARS unit.

The collaborative administrative application 506 will be exemplified in more detail below. It may be an application implemented in Java, C++, or another suitable programming language. The collaborative administrative application 506 may use its own designated data store or that of the store network management application 504 to store configuration information (e.g., product presentations and their attributes that may be still in draft mode). Once a change is authorized for deployment, the collaborative administrative application 506 needs to update the data store 510 with the new/revised data, either by direct access to the data store 510 or through an integration process.

In certain embodiments, the collaborative administrative application 506 includes a web-interface. Individuals employed by or representing brand owners 514 may provide login information, for example, prior to accessing the collaborative administrative application 506. The data center 502 may provide access rules specific for different users of the collaborative administrative application 506. For example, some rules may give users access to all aspects of the brand owner's data including all product presentations and all reporting data from the brand products sold at the ARS units (e.g., sales performance of individual stores). Other rules may limit user access to pre-selected aspects of the brand owner's product presentations (e.g., only certain templates used to create new product presentations). In general, each brand owner 514 can only access the presentations and data for its own products. Of course, there may be situations where brand owners 514 collaborate and share portions of their data relevant to the collaboration.

In many embodiments, the collaborative administrative application 506 enables the brand owners 514 to update their existing product presentations and create new product presentations using formats, such as Microsoft Excel file format (XLS), comma-separated values (CSV) format, and XML format. In some embodiments, the collaborative administrative application 506 allows the brand owners 514 to upload data about vending of their products at the ARS units 500a-c. It may also permit the brand owners 514 to use such data for product presentations and to generate and view reports.

The ERP module 508 is a system for managing the data pertaining to financial transactions and inventory management of the ARS units 500a-c. The ERP 508 may process information received from ARS units through the store network management application 504, such as current inventories and sales data. The ERP 508 may also process information from 3PL services 518, such as warehouse inventory availability, restocking requests, and the like. The ERP module 508 may exchange data with the 3PL services 518. For example, the ERP module 508 may prepare and communicate restocking requests to the 3PL services 518. In certain embodiments, the ERP 508 is configured to exchange information with an ERP module 519 of the 3PL services 518. The ERP module 508 may be partitioned into multiple sub-modules, in some cases running on separate processing devices, depending on the number and location of ARS units, the variety of products offered for sale, number of parties involved, ARS unit logistics, and other parameters.

In certain embodiments, the system administrator 516 can access all modules of the data center 502. He or she may have access to the all levels of brand owner information, or only certain less sensitive information. In some implementations, the system administrator 516 may review, change, and publish product presentations in either the collaborative administrative application 506 or the store network management application 504. The system administrator 516 may manage error messages, service requests, and other issues specific to ARS units in the store network management application 504. Similarly, in some embodiments, the system administrator 516 may review the inventory related data in the ERP 508 and set parameters for managing this inventory. For example, the system administrator 516 may review requests for rerouting products between the ARS units based on relative sales performances, create triggering points for restocking requests based on sales trends, and so forth.

Examples of the 3PL services 518 include product distributors and other services used for managing inventory on ARS units. In a specific example, several different 3PL services 518 entities are involved in replenishing the inventory of ARS units. The ERP 519 may send restocking requests to both a distributor and a restocking service. The distributor may then ship requested products to a pick-up location near the designated ARS units. The restocking service then picks up the shipment and replenishes the inventory of the ARS units.

As indicated above, each of the ARS units 500a-c is connected to a network or a plurality of networks 444 using a network interface. The ARS units 500a-c may be configured to initiate communication through the networks 444 with any other entities and ignore all or some incoming requests for communication. Such functionality may be implemented for security reasons (for example, to avoid unauthorized access to the ARS units 500a-c). In addition to being configured to communicate with the server (or servers) hosting the store network management application 504, the ARS units 500a-c may also be configured to communicate with other systems (which may be servers) such as, for example, payment switches 526, anti-fraud services providers 528, and loyalty program providers 524.

In general, the payment switch 526 may be any payment processing service that can authorize payments tendered using credit cards, debit cards, gift cards, or any other forms. The ARS units 500a-c may be configured to use a pluggable payment architecture that allows them to accept multiple forms of tender and send the payment traffic to different services depending on the tender type and the corresponding designation of the store. In certain embodiments, a brand owner 514 may choose to accept only certain types of payments and only specific methods of processing these. For example, selected types of credit and debit cards may be processed by one payment service, while gift cards may be redeemed by another. The payment switch 526 may direct the traffic accordingly. In certain embodiments, a customer may use multiple payment services for the same purchase (e.g., a split tender). For example, a customer may charge a certain amount on one credit card or a gift card and use one or more other credit cards, gift cards, cash, or any other forms of accepted payments for the remaining balance.

The anti-fraud services 528 may be used to verify information about a particular payment (e.g., verify the identity of a credit card user, control purchasing patterns, etc). The ARS units 500a-c may be configured to communicate with the anti-fraud services 528 in order to decide on whether to permit a particular purchase. The ARS units 500a-c may also be configured to determine when to invoke communication with the anti-fraud service 528 and initiate gathering some information from a customer based on a set of parameters pertaining to payment, such as amounts, payment types, shopping patterns, and so forth. In certain embodiments, the ARS units 500a-c are configured to request that a customer to provide personally identifying information, such as a zip code and/or the last four digits of their social security number. The ARS units 500a-c then sends this information to the anti-fraud services 528 for verification. In this or another embodiment, the anti-fraud services 528 may also perform velocity checks against all or a sub-set of ARS units 500a-c. For example, the anti-fraud service 528 may identify when and where the same credit card number was used in the network system including the ARS units 500a-c. Selection of anti-fraud services 528, security configurations, and the like may be specific to each store.

The ARS units 500a-c may be configured to participate in different loyalty programs and interact with the corresponding loyalty program providers 524. For example, a brand owner 514 may designate a specific loyalty program for the ARS units 500a-c carrying products of a particular brand. In another embodiment, an ARS unit operator may establish a loyalty program to promote purchasing and gather customer information from specific ARS units. Loyalty programs typically gather basic personal information and purchasing trends of customers in exchange of some incentives, such as discounts, redeemable membership points, and so forth. Moreover, the ARS units 500a-c may be configured to use selected third party loyalty programs (for example, programs implemented by credit card companies). An ARS unit may prompt a customer about the availability of loyalty programs and inquire whether the customer may be interested in selecting one and providing membership information. An ARS unit may indicate any incentives offered by available loyalty programs. Additionally, an ARS unit may offer customers membership in one or more loyalty programs.

In certain embodiments, a customer can provide membership identification information to an ARS unit either by swiping a card, entering codes on a touch screen or a set of buttons, or other means. The ARS units 500a-c may contact the corresponding loyalty program provider 524 and retrieve membership information. Alternatively, the ARS units 500a-c may keep limited membership information in its own secure data storage medium and retrieve the information locally. The store can then use the information to greet the customer by name, to tailor certain aspects of the shopping experience (e.g., fill in zip code or shipping address automatically), to allow the customer to redeem membership points as full or partial payment for products, and/or to credit the customer with membership points for purchases. Each ARS unit may be configured individually with a specific set of loyalty programs, choices available to customers, gathered information, offers presented, and other parameters.

In the above-described embodiments, the ARS units 500a-c communicate directly with the loyalty program provider 524, payment switch provider 526, and anti-fraud service provider 528. In certain embodiments, communications with one or more (including all) of these services is conducted through the data center 502 in some or all situations. In such situations, the individual ARS units 500a-c requiring the service may not directly communicate with the service and instead communicate only with the data center 502, which acts as a proxy for the ARS units when accessing the requisite service(s).

The networked system described above is capable of transferring data between the data center and one or more vending stores as further described in U.S. application Ser. No. 12/603,809, entitled “VENDING STORE INVENTORY MANAGEMENT AND REPORTING SYSTEM,” filed on Oct. 22, 2008, (Attorney Docket No. ZOOMP003US), which is incorporated herein by reference for purpose of describing data transferring features. Furthermore, the system may used for establishing and developing an ARS concept. The ARS concept may define various features and/or operational details of one or more ARSs. These concepts and associated methods are described in U.S. application Ser. No. 12/603,809, entitled “VENDING STORE INVENTORY MANAGEMENT AND REPORTING SYSTEM,” filed on Oct. 22, 2008, (Attorney Docket No. ZOOMP003US), which is incorporated herein by reference for purpose of describing ARS concepts and related methods.

An ARS may be equipped with one or more sensors for gathering information associated with customers, customers' interactions with the ARS, and the retail environment. Various examples of sensors and associated methods are described in U.S. application Ser. No. 12/603,809, entitled “VENDING STORE INVENTORY MANAGEMENT AND REPORTING SYSTEM,” filed on Oct. 22, 2008, (Attorney Docket No. ZOOMP003US), which is incorporated herein by reference for purpose of describing sensors and associated methods.

### User Interface Screens

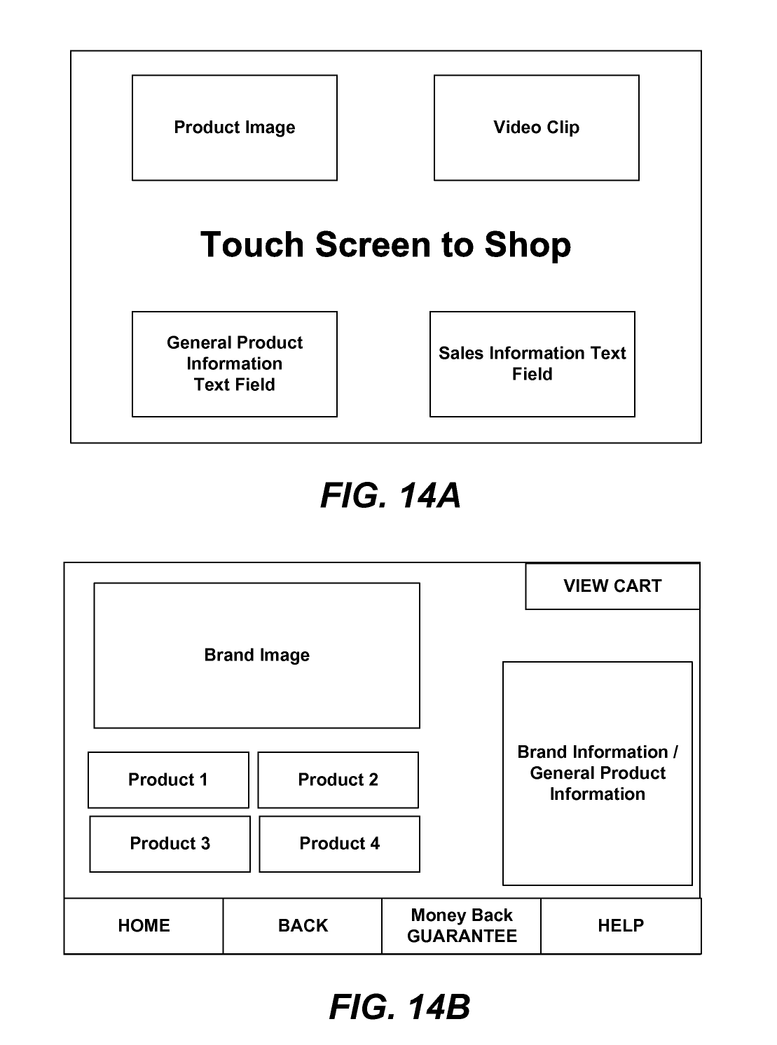

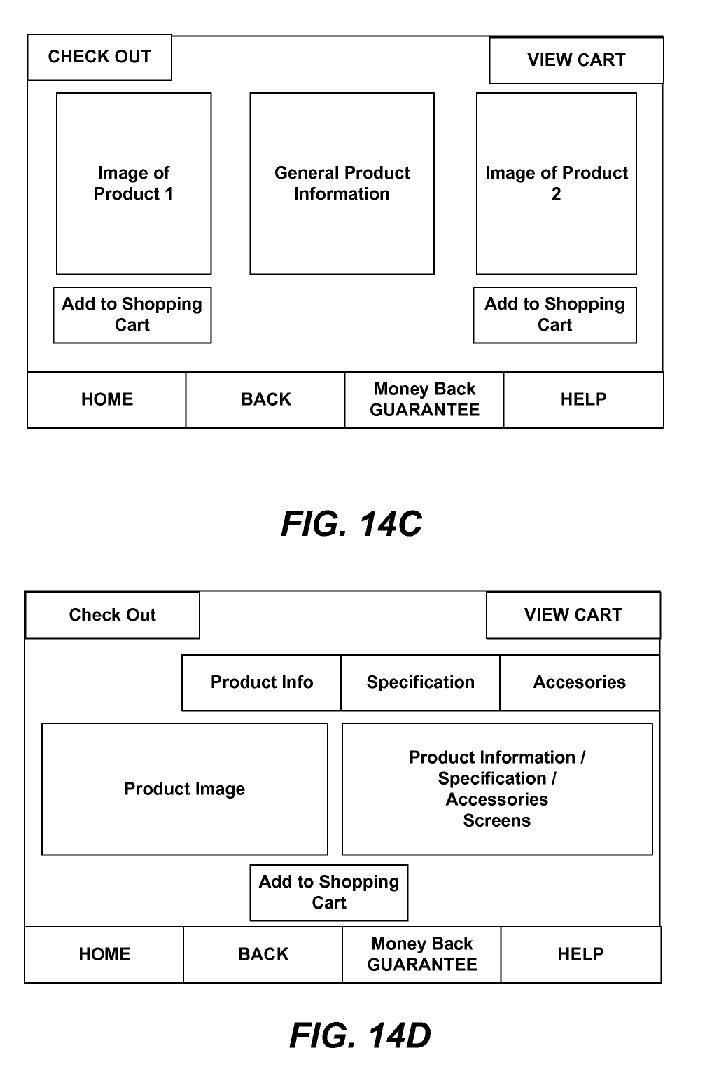

Screen types may belong to one of many categories determined by the wireframe architecture. FIGS. 14A-D illustrate four examples of the screen types, in accordance with certain embodiments. FIG. 14A illustrates an example of a “screensaver” that can include an attract loop and various screen elements (e.g., product images, video clips, product information, sales information). The purpose of the screensaver is to capture the attention of a customer who is close to the user interface but has not yet initiated any interactions with the interface. It also preserves the screen itself by preventing image burn. It may optionally be part of a product presentation or more generally part of the store's GUI.

FIG. 14B illustrates an example of a “home screen,” which is brought up on the user interface immediately after the customer initiates some interaction with the user interface or triggers one of the sensors. The home screen may include some brand information and general product information. A customer can access additional information by providing some input on the user interface (e.g., touching a designated area on the touch screen). For example, a screen may include one or more buttons that would direct the customer to one of the product category screens or one of the product screens.

FIG. 14C illustrates an example of a “product category screen” (or simply a “category screen”), in accordance with certain embodiments. Such a screen typically includes links to one or more product screens and some general information about this product category (e.g., media players, digital camera). A brand owner may choose to categorize its products for ease of navigation among the product screens.

FIG. 14D illustrates an example of a “product screen,” in accordance with certain embodiments. It contains information specific to a particular product item, such as a product image, product price, options, product information, product specification, available accessories, and so forth. It also includes an option of adding a product item represented by that screen to the shopping cart.

Generally, a home screen, a category screen, and a product screen include a set of navigation links (e.g., “home”, “back”, “help”, etc.) that direct a customer to other screens. Further, in certain embodiments, the home screen, the category screen, and the product screen include a shopping cart area (shown in the upper right corners of FIGS. 14B-D) that appear prior to the checkout. It may show the total payment amount and the total number of items currently in the cart. It may correspond to the input that invokes the “shopping cart” screen.

Other types of screens (not shown) include a shopping cart screen, a help screen, a return policy screen, a product comparison screen, a cross-sell/up-sell screen, a survey screen, a multimedia presentation screen, a wizards screen, an advertisement and promotions screen, a loyalty screen, a payment screen and a fraud parameters screen. For example, the shopping cart screen may allow customers to collect and view selected products before they pay for them. Comparison screens may be used to help customers determine the differences between multiple products offered for sale in the ARS unit (or elsewhere). For example, a comparison screen may show side-by-side selected portions of product specifications. When a customer adds a product to the shopping cart, a user interface may invoke a cross-sell/up-sell screen to help the customer to find other available products. A survey screen may be displayed after the customer pays for the product and while the ARS unit is dispensing products. The screen may invite the customer to participate in a survey that collects demographic and shopping experience information. Multimedia viewing screens may be used for product demonstrations, tips, and previews. Wizard screens can be used as an interactive tool to help customers to compare and choose between similar products. Finally, advertisements and promotion screens can display various marketing materials. Loyalty screens can collect or display loyalty program information, while payment screens may be used to inform customers about the pay process (e.g., instructing a use to swipe his or her credit card). Fraud prevention screens may collect personally identifiable information to check for fraud.

The networked system described above may include and support a collaborative administrative application, which may be designed to provide a controlled access to product information to different users, such as brand owners. Various examples of the collaborative administrative application and associated processes are described in U.S. application Ser. No. 12/603,809, entitled “VENDING STORE INVENTORY MANAGEMENT AND REPORTING SYSTEM,” filed on Oct. 22, 2008, (Attorney Docket No. ZOOMP003US), which is incorporated herein by reference for purpose of describing the collaborative administrative application and associated processes.

### Purchase Process

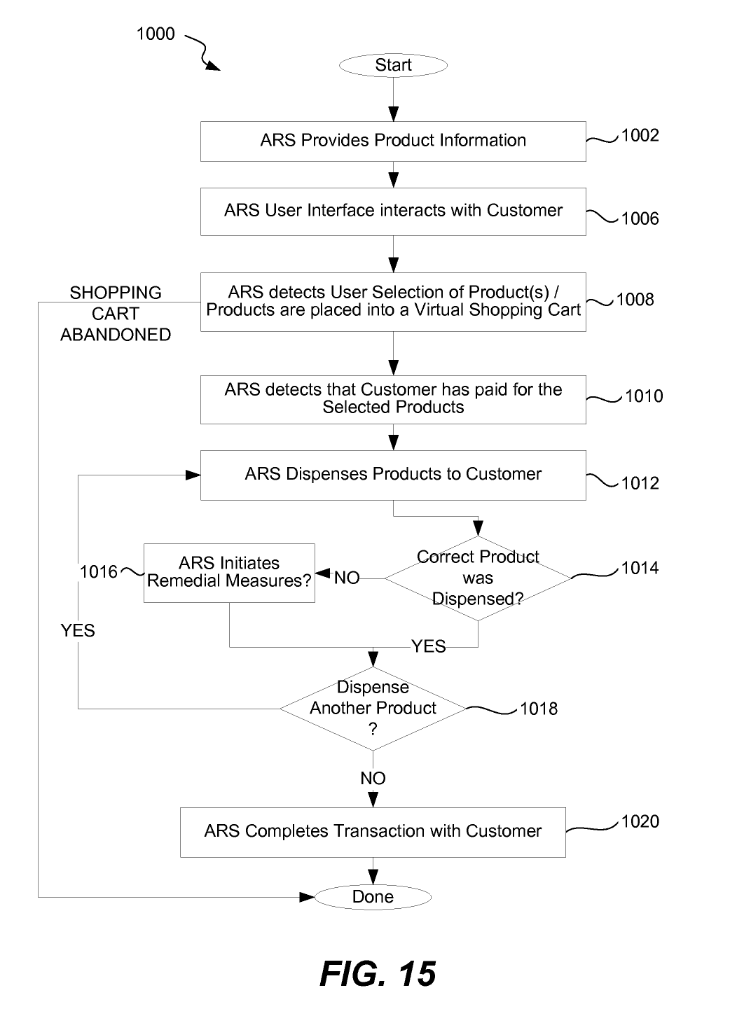

FIG. 15 is a flowchart corresponding to a process 1000 by which an ARS unit may respond to customer actions, in accordance with certain embodiments. In the depicted example, the process starts with an ARS unit entering an attract mode in which it displays or presents some product or store information or otherwise invites customers to start an interaction (block 1002). Such presentation is conducted through the ARS unit's user interface using, for example, visual, audible, and/or mechanical modes of presentation. Such presentations may be driven by a predetermined set of rules and inputs (for example, responses from proximity sensors).

The ARS unit user interface may transition to a different mode in response to receiving defined input from a user (block 1006); for example, the user may touch a touch screen or trigger one of the proximity sensors. In certain embodiments, the ARS unit has voice recognition features used to initiate audio interaction with the customer. In response to receiving a triggering interaction, the ARS unit, through its user interface, may deliver a welcoming message. The user interface may then lead the customer to appropriate product information in the form of, for example, product presentations (e.g., catalog pages, product pages, or an advertisement) and/or various options, such as a help menu, payments, customer service, and loyalty club services.

This interaction with the user interface may lead the customer to select one or more products for purchase (e.g., by adding information about such products to a virtual shopping cart depicted via the ARS unit user interface). The user interface detects this selection and changes state, as appropriate, to reflect this selection (block 1008). In response to detecting particular user selections, the ARS unit may analyze such selections (e.g., the content of the shopping cart) and suggest, via presentation of new information, other products and services available from the store or other retail locations. For example, if the ARS unit detects a digital camera in the shopping cart, the store may display information encouraging the user to also select a memory card, a battery, an extended warranty, and/or photo printing services. From the software perspective, services and non-tangible products offered by an ARS units, such as warranties and uploading media files to the customer's device, are handled by the overall system as inventory objects without inventory limits. Non-tangible products do not require physical dispensing but may be transferred as electronic files to the customer's device or media carrier using a direct connection to the ARS unit (e.g., wire, Wi-Fi, Bluetooth, etc.) or an indirect connection (e.g., an ARS unit sends an e-mail with the file or a link to the file). Further, some products may be offered as media files that are recorded on media carriers stored in an ARS unit (e.g., burning a movie on a Digital Video Disk (DVD) or Blue-Ray disk, uploading song libraries on to a flash card). In such cases, both media files and media carrier may determine product description and other characteristics (e.g., pricing, inventory).

In certain embodiments, an ARS unit offers gift cards for purchasing. Such cards may be stored in a designated product storage area of the ARS unit and dispensed in a manner similar to that of other product items or they may be dispensed via a specialized card dispenser. For example, in certain embodiments, gift cards are dispensed via a cardholder on a side of the ARS unit and there made available for retrieval and activation by customers. In either approach, gift cards may be made available to customers for selection via the ARS unit user interface for retrieval and subsequent activation. Using the user interface, the customer can enter a chosen value for the gift card or select one of various values displayed as options via the user interface. For activation, a customer may be instructed to provide additional information such as the type of products that be purchased, the geographic locations and/or retailers where purchases can take place, and the like. In certain embodiments, the ARS unit then adds an item representing the gift card to the virtual shopping card. Some or all parts of the gift card purchase can proceed in the same manner employed to purchase other items from an ARS unit. Once the payment is processed, the ARS unit communicates the information on the card, if appropriate, to a corresponding loyalty club service provider or other entity, which effectively activates the card. This information is then used by the networked system and, possibly, other entities outside of the networked system to redeem the card.

In certain embodiments, the ARS unit is equipped to read from and write to gift cards and may be configured, as well, to redeem gift cards fully or partially. For example, an ARS unit may be equipped with a magnetic card reader, a bar code reader, an RFID reader, or any other suitable data acquisition and/or recording device.

In certain embodiments, the ARS unit may be equipped to redeem gift cards and record new information on cards during the gift card purchasing process. An ARS unit may be supplied with the gift card activation information by one or more gift card vendors before any purchasing occurs. Alternatively, the ARS unit simply reads a card presented by a purchaser at the time of payment, applies the value stored on the card to pay for purchased items and writes a new value on the card. Thus, when a customer completes the payment operation, the ARS unit records corresponding gift card activation information to the gift card. In these example embodiments, ARS units optionally need not communicate the transaction to the card vendor.

Returning to the description of the general purchase process, a customer may sometimes encounter that a desired product item is not available for immediate delivery from the ARS unit. The reasons may include a product item is out of stock, an ARS unit's has mechanically malfunctioned (e.g., a problem with a delivery system), an ARS unit has advertised a product item that will be available only in the future or is available only in other retail location (e.g., drive back purposes, offering of complementary products and services that can not be delivered from an ARS unit), and so forth. In such situations, a customer may be offered information on where such product item is available (e.g., a nearest corresponding retail location, such as another ARS unit or a traditional retail outlet, offered an option to reserve the product item (e.g., after paying a nominal deposit), or offered an option to pay for the product at the ARS unit and then receive the product item from another location (e.g., shipped to the customer's address).

At some point during interaction with the ARS unit user interface, a customer may indicate that the product selection is completed and the user interface of the vending machine may present an option to initiate a payment operation (block 1010). For example, a user interface may display a “Pay Now” or similar message that may be selected by a customer to proceed to the payment operation 1010. In some cases, a potential customer may select one or more product items and then leave. Such situations are sometimes referred to as abandonment. In such cases, the operation 1010 is not invoked. Typically, an ARS unit waits for a predetermined period of time (e.g., about 1 minute, 2 minutes, 5 minutes, or 10 minutes) to determine whether any further user interactions with the user interface will be forthcoming. If no interactions follow, the ARS unit empties a shopping cart and reconfigures into the original mode. A user interface may provide a field or icon (e.g., a resetting button) that accomplishes the same function without a need to wait for the predetermined period of time. For example, the next customer may want to start interacting with the ARS unit immediately after the previous customer left and would like all previous information and selections to be ignored. Also, customers may prefer deleting their selections from ARS units before leaving the ARS unit without making purchases.

If the ARS unit determines that a customer has elected to proceed with the payment operation 1010, the ARS unit may proceed directly to requesting and receiving payment for the purchase. In some implementations and/or in certain retail situations, the ARS unit interface first presents options to the customer prior to collecting payment. For example, an ARS unit may indicate availability of loyalty club services, suggest additional products and services (e.g., complimentary to the selected products), or provide other services, which are further described in corresponding sections of this document. Thereafter, the payment operation 1010 is invoked. It may start with an ARS unit presenting payment options (e.g., credit card, debit card, membership points, instant credit, cash, and the like).

Continuing with the process, the ARS unit attempts to dispense the purchased product to the customer (block 1012). As part of the dispensing process, the ARS unit determines whether the product was correctly dispensed (decision block 1014). Various internal sensors and/or feedback from the customer may be employed to allow the ARS unit to make this determination. If the ARS unit determines that it failed to correctly dispense the purchased product (decision block 1014 is answered in the negative), then the ARS unit may initiate certain remedial measures (block 1016). In some embodiments, an ARS unit may request that the customer confirm that the ARS unit dispensed the product items that were selected. In certain embodiments, the store may request such confirmation after the dispensing of every item or only certain predetermined products (e.g., high priced items) during the dispensing operation (block 1014). Confirmation may be done by providing input on the touch-screen, scanning a product identification (e.g., a UPC barcode, an Electronic Product Code encoded on the RFID tag), or other forms of input. The store may compare the customer's input to response from the sensors used to monitor the dispensing of the product.

In some situations, the ARS unit dispenses an incorrect item. The remedial measures configured into the ARS unit may include providing means for returning incorrectly dispensed product items back into the ARS unit, providing a receipt indicating the discrepancy and directions for returning the incorrectly dispensed items to another location (e.g., another ARS unit capable of accepting products, a traditional retail location, or a customer service location), and providing incentives to the customer to keep the incorrectly dispensed items. In certain embodiments, an ARS unit may initiate a communication session with one or more of the call centers, and the call center operator assists the ARS unit in resolving the dispensing problem.

In other situations, an ARS unit may fail to dispense any item. For example, an item may have been available for selection through the user interface, but was not physically present in the product storage compartment. In other examples, a dispensing mechanism may fail after the item has been selected. In any case, a remedial measure is invoked when a selected item is not dispensed to the customer. In certain embodiments, the ARS unit indicates to the customer that he or she will not be charged for the items that have not been dispensed. The store may also offer the customer the opportunity to cancel the entire transaction or some part of it. Further, when the purchaser has selected a series of items for purchase or has left open the possibility that other purchases will be made, the ARS unit may, through its user interface, show the purchaser that additional items are available for dispensing (e.g., when the store dispensing mechanism is still functional and capable of dispensing other items). In the situations where at least one item is kept by the customer (i.e., the entire transaction is not aborted), the ARS unit may adjust the payment obligations accordingly (to reflect the new adjusted total amount) and/or provide a credit or refund to the user.

Assuming that all of a customer's purchased products that the store has attempted to dispense were determined to have been correctly dispensed or any incorrectly dispensed products have been accounted for by remedial measures, the ARS unit determines whether additional products are to be dispensed for the customer (block 1018). If so, the process continues as depicted in FIG. 15 by returning to process block 1012. If not, the ARS unit completes the transaction in an operation 1020. At this point, the ARS unit may print a receipt indicating a list of products selected and dispensed, payment amount, and coupons. The store may ask the customer to take a survey that includes a set of questions about selected product and retail venue (e.g., why the purchase was made from this ARS unit), the customer's opinion about the transaction, and other questions tailored to gather information that may be of interest to various parties involved in the networked system.

In certain embodiments, some operations of the purchasing process 1000 illustrated in FIG. 15 may be performed by different ARS units or other apparatuses on a network. For example, a product may be selected and, in some examples, paid for at one ARS unit (or a retail location, or a computer system connected to the networked system) and retrieved from another ARS unit. The ARS unit may be configured to determine a product item's availability from different constituents (e.g., other ARS units, retail locations, warehouses, or even future deliveries) of the networked system and assist the customer with at least certain operations of the overall process.

Product purchasing operations described above may be associated with certain payment processing techniques further described in U.S. application Ser. No. 12/603,809, entitled “ARS UNIT INVENTORY MANAGEMENT AND REPORTING SYSTEM,” filed on Oct. 22, 2008, (Attorney Docket No. ZOOMP003US), which is incorporated herein by reference for purpose of describing payment processing techniques.

### Inventory Management

A store network management application module in combination with an ERP module and various external services allow the ARS unit operator to provide multiple supply chain functionalities. For example, an ARS unit operator may manage all movements of merchandise among 3PL services, which may include brand owner or retail warehouses, replenishment carriers (are also referred to as restocking service providers), and actual ARS units.

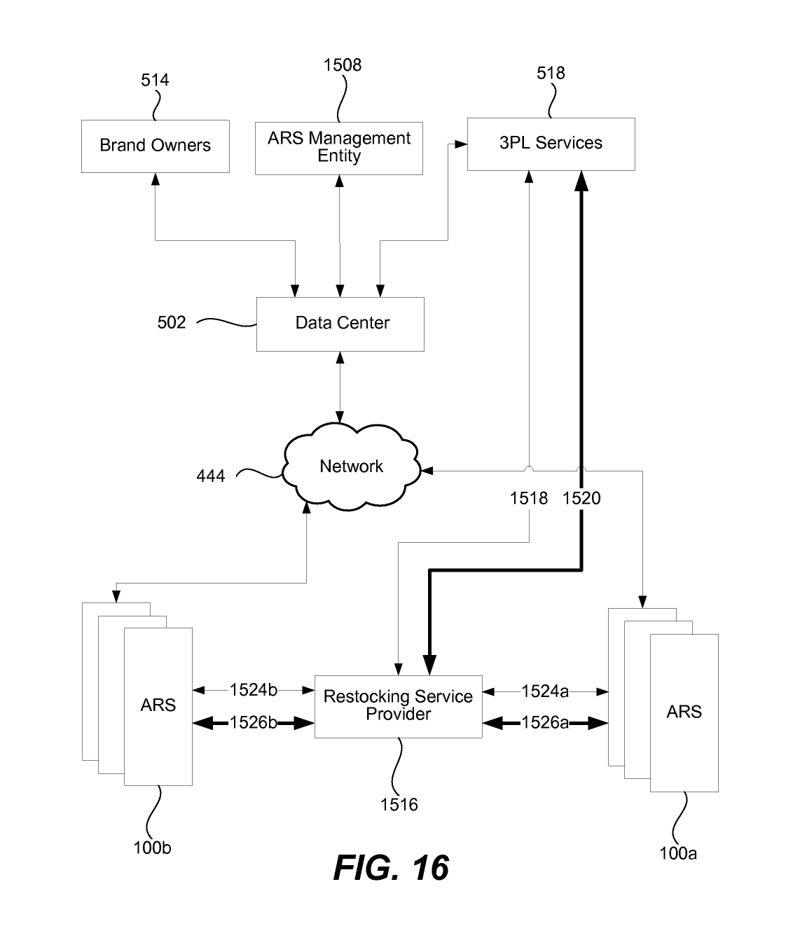

FIG. 16 is an example block diagram showing interactions among various entities involved in managing the inventory of ARS units, in accordance with certain embodiments. The thin lines represent information flow, while the thick lines (1520, 1526a, and 1526b) represent the product flow. Three types of entities, specifically the brand owners 514, the ARS unit management entity 1508, and 3PL services 518, communicate with the data center 502. In addition, the data center 502 communicates with ARS units 100a and 100b via a network 444. For example, the ARS units 100a-b may send inventory information to the data center 502. The data center 502 then processes this information and sends restocking requests to the 3PL services 518. The 3PL services 518 use these requests to pack the products and ship (line 1520) them to restocking service providers 1516. The 3PL service 518 may also send information (line 1518) on the shipment to the restocking service provider 1516. In certain embodiments, this may be a packing slip included with the package. In another or the same embodiment, this may be an electronic data transfer between the two entities.

The 3PL services 518 also communicate the information on the shipments to the data center 502, which then processes this information and further sends it to the ARS units 100a and 100b. Once the restocking service provider 1516 receives the shipment (line 1520) it moves the shipped product to the designated stores 100a and 100b. The inventory transfer at this stage is shown with lines 1526a and 1526b. The ARS units 100a and 100b may prompt the restocking service provider 1516 to confirm the information received by the ARS units 100a and 100b from the data center 502. The process of confirming the information against the packing slip and the actual products received is shown with lines 1524a and 1524b. The store may also include an algorithm to deal with discrepancies. Moreover, the ARS units 100a-b may direct the restocking service provider 1516 to move some of its own inventory or redirect some of the incoming inventory to another ARS unit, which is also illustrated by lines 1526a and 1526b.

### Data Collection and Reporting

A network system may be configured to generate various reports for ARS unit operators and brand owners. An ARS unit operator may set a number of standard reports that include the most typical data available on or from the ARS units corresponding to a specific brand owner and/or retailer. Examples of such reports include sales and inventory snapshots, business review reports, and sales per product compartment. For example, an ARS unit operator may provide a daily report indicating the previous day's sales and inventory for each store. A more comprehensive report may be sent on a weekly basis and include, for example, historical sales data (e.g., sales per machine over the last four weeks) for each product, sales mix percentages, inventory information (e.g., inventory remaining at the end of a period, the anticipated number of weeks of supply, out-of-stock, in-stock, and in transit). Higher level reports may include performance tracking as related to established goals, comparable performance to other stores, individual store sales and margins, sales per item and overall statistics for each item, average selling prices, unique user sessions (i.e., when a new customer touches the screen after the store enters the idle mode), and conversions. For example, a brand owner may be supplied with a report for each ARS unit assigned to the brand owner that indicates: a number of days since the last sale, a price of the mostly recently sold item, a percentage of items that are currently in stock, a number of items that are out of stock, and various data points for a predetermined period (e.g., total sales, a number of transactions, a number of user sessions, a conversion rate, an abandonment rate, a number and a rate of card reader errors). The data may be presented in a form of dash boards indicating both the current data and the trends, reports varying in types and granularity of data, and other formats appropriate for each particular user.

Other types of reports may inform ARS unit operators and brand owners about network status and availability (e.g., number of hours certain stores or supporting data centers have been processing sales transactions), mis-vend reports (e.g., specific transactions where purchased items were not vended), and survey information and analysis reports (e.g., gathered information and application of business analytics). For example, a brand owner may be updated on how many surveys were completed relative to the total number of the transactions on one or more ARS units and various data collected in the surveys (e.g., gender, age group, purpose of shopping, ethnicity, income level, evaluation of the transaction experience, last purchase information, suggested improvements, e-mail, zip code, and other information). In certain embodiments, information collected in the surveys is combined with information obtained from sensors, payment processing, and other ways to develop a report.

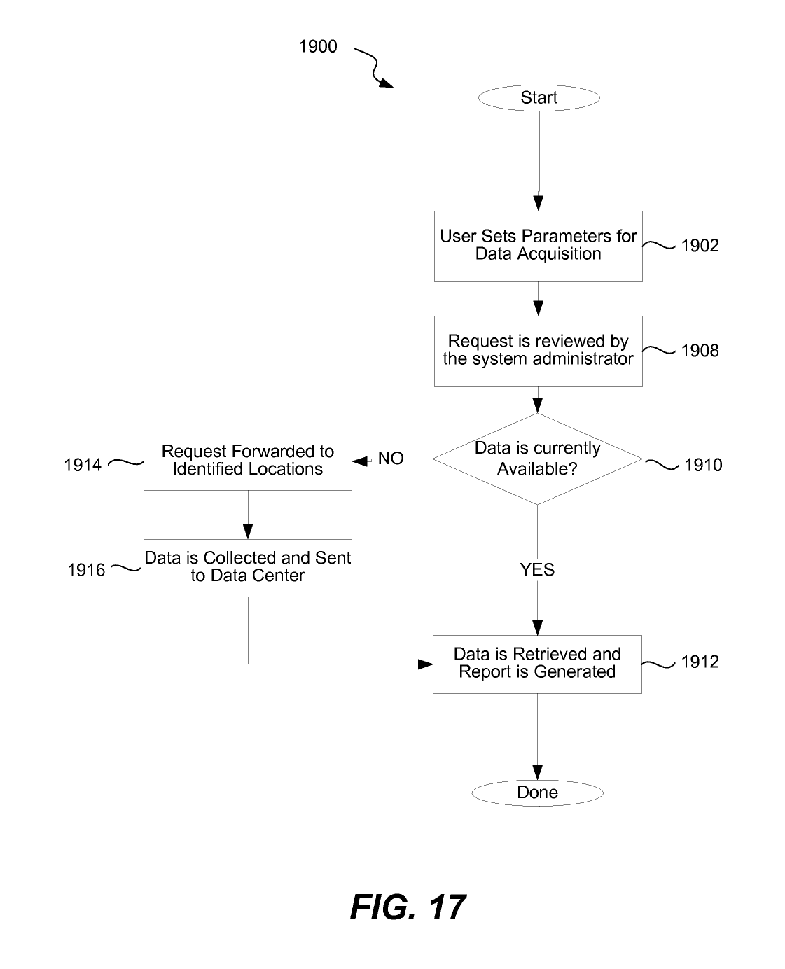

FIG. 17 is a flowchart corresponding to a process 1900 for collecting data from different components of a networked system and presenting this data to authorized users, in accordance with certain embodiments. Such data may be collected by ARS units and may include, for example, sales, inventory, customer interactions, loyalty programs details, store availability (e.g., a period when a given store was operational during a predetermined period divided by the total number of retail hours in the period), store configuration, and so forth. As discussed above, such data may include sales data, inventory data, and/or customer interaction data. Data associated with customer interactions include, for example, abandonment rate (i.e., the percentage of potential customers that start the purchase process (e.g., by providing at least one item in a shopping cart at an ARS unit) but do not complete a purchase), conversion rate, number of specific inquires at a user interface, proximity sensor response, and many other data points described in other parts of this document.

Collection and reporting of the data (collectively, “data management” in the context of this application) in the networked system may be centrally controlled, for example, by the data center 502. The data center 502 may include a designated application for data management or may incorporate data management functions into one of the existing applications, such as the collaborative administrative application 506 or the store network management application 504. Any form of software or logic implementation is generically referred to as a “data application.”

In certain embodiments, the data application requires that a user provide user identification or authentication information before accessing the application and/or the data available via the application. The application uses this information to determine an access level and, in certain embodiments, services available to the identified user.

ARS unit management entity 1508 can use the data application and various components of the networked system to provide various data collection options. For example, the entity may specifically configure an ARS unit's hardware (e.g., install or activate additional sensors) and/or software (e.g., identify data collection points or triggers during a user's interaction with a user interface).

Once the user is identified and the corresponding access level is determined, the user may be presented with one or more interfaces of the data application, such as an interface for requesting new data, an interface for searching available data, an interface for viewing data, an interface for reporting data, an interface for running reports, and/or other interfaces.

The data requesting interface is used to set various parameters for data collection (see block 1902). For example, the interface may have multiple fields to identify data types and other data parameters (e.g., time periods and/or specific ARS units) and to select presentation formats and delivery options. Optionally, the completed request may be reviewed by a system administrator or another appropriate reviewer (block 1908) to determine whether the requested data is being routinely collected, whether collecting requested data would require changes in hardware and/or software configurations, or any other potential issues associated with executing the request. In certain embodiments, the data application itself or another module of the data center 502 performs an automated review. The reviewer may then address the issues and notify the requestor.

In some cases, if the requested data may be available only through a change in hardware and/or software configuration of the corresponding ARS units, then the reviewer may enter a work order for such changes or deny the request. For example, a user may request information on how many times a particular product page has been viewed by customers on the user interface of a particular ARS unit. Such a request does not involve hardware configuration changes but requires the computer system of the ARS unit to register and report back to the data center 502 how many times the file corresponding to the particular product page has been invoked by the servlets of the web-server and then applets of the browser. As described above, the store network management application 504 provides software configuration updates to ARS units. The data application may deliver a request to the store network management application 504 to change software configurations of the ARS unit in order to enable collection of the requested data.

The data application may then review the requested data to determine whether it is immediately available from one or more of data stores (block 1910). It should be noted that, in some embodiments, the data availability determination at block 1910 is performed before the request review operation at block 1908. In some implementations, the network system may be configured to routinely collect and store some frequently requested data, such as sales, inventory, and ARS unit configurations. Such data may be retained for a predetermined period, such as 10 years, 1 year, 1 month, or 1 week. If the data application determines that the requested data is immediately available, then it retrieves the requested data and generates a report (block 1912). The report may be generated based on one or more templates provided by a user or system administrator.

If the requested data is not immediately available, then the data application generates a request for collecting the requested data from the corresponding elements of the networked system (block 1914). The requested data may come from one or more of various resources available on the network. For example, inventory reconciliation data may come from the 3PL services 518, restocking service providers 1516, and ARS units 100a-c. The requested data is then collected and communicated back to the data center 502 in the operation represented by block 1916. Finally, the requested data is reported to the user (block 1912) as described above.

### Digital Apparatus

As should be apparent, various embodiments employ processes acting under control of instructions and/or data stored in or transferred through one or more computer systems. Embodiments also relate to apparatus for performing these operations. Such apparatus may be specially designed and/or constructed for various purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein. In some cases, however, it may be more convenient to construct a specialized apparatus to perform the various operations described above. A particular structure for a variety of these machines will appear from the description given below.

In addition, certain embodiments relate to computer readable media or computer program products that include program instructions and/or data (including data structures) for performing various computer-implemented operations. Examples of computer-readable media include, but are not limited to, magnetic media such as those conventionally deployed in disk drives; optical media such as CD-ROM devices and holographic devices; magneto-optical media; semiconductor memory devices, and hardware devices that are specially configured to store and perform program instructions, such as ROMs and RAMs, and sometimes application-specific integrated circuits (ASICs), programmable logic devices (PLDs) and signal transmission media for delivering computer-readable instructions, such as local area networks, wide area networks, and the Internet. The data and program instructions may also be embodied on a tangible transport medium or a tangible storage medium.

Examples of program instructions include both low-level code, such as produced by a compiler, and files containing higher level code that may be executed by the computer using an interpreter. Further, the program instructions include machine code, source code and any other code that directly or indirectly controls operation of a computing machine in accordance with this invention. The code may specify input, output, calculations, conditionals, branches, iterative loops, and the like.

Any controller or computer optionally includes a monitor. Computer circuitry is deployed in one or more confined systems, each of which includes integrated circuit chips, such as a microprocessor, memory, interface circuits, and others. The system also optionally includes a hard disk drive, a high capacity removable drive such as a writeable CD-ROM, semiconductor memory, and other common peripheral elements. Inputting devices, such as a keyboard, microphone, and/or mouse, optionally provide for input from a user and for user selection of sequences to be compared or otherwise manipulated in the relevant computer system.

The computer typically includes appropriate software for receiving user instructions, either in the form of user input into a set parameter fields (e.g., in a GUI), or in the form of preprogrammed instructions (e.g., preprogrammed for a variety of different specific operations). The software then converts these instructions to appropriate language for instructing the system to carry out any desired operation.

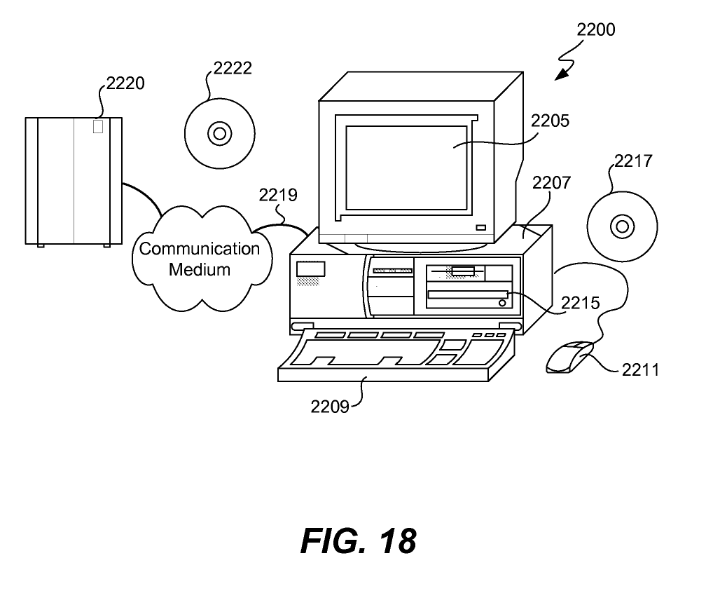

In one example, code embodying methods is embodied in a fixed media or transmissible program component containing logic instructions and/or data that when loaded into an appropriately configured computing device causes the device to perform various operations described in this document. FIG. 18 is a schematic representation of a digital apparatus 2200 for use in an ARS unit, in accordance with certain embodiments. Digital apparatus 2200 may be understood to be a logical apparatus that can read instructions from media 2217, network port 2219 for communicating with external devices 2220 (via, e.g., a network or some other communication medium), user input keyboard 2209, user input device 2211. or other inputting means. One type of logical apparatus is a computer system as in digital apparatus 2200 comprising CPU 2207, optional user input devices keyboard 2209, and pointing device 2211, as well as peripheral components such as disk drives 2215 and monitor 2205. Fixed media 2217 is optionally used to program the overall system and can include, for example, a disk-type optical 2222 or magnetic media or other electronic memory storage element. Communication port 2219 can be used to program the system and can represent any type of communication connection.

What is claimed is:

1. An automated retail shelf unit comprising:
a chassis sized and configured to fit on an elevated shelf in a retail environment;
a product storage compartment for securely storing one or more saleable product items within the chassis; and
a user interface section provided on a front side of the chassis and configured to face a customer in the retail environment, wherein the user interface section comprises
a detecting feature for detecting customer selection of a product item available from the product storage compartment,
a payment feature for accepting and processing a cashless payment from the customer for the selected product, and
a dispensing feature for dispensing the product item selected and paid for by the customer.

2. The automated retail shelf unit of claim 1, further comprising an additional product storage compartment, wherein the user interface section is provided in between the product storage compartment and the additional product storage compartment.

3. The automated retail shelf unit of claim 2, wherein the product storage compartment, the user interface section, and the additional product storage compartment are arranged along the length of the chassis, and wherein the length of the chassis is longer than the height of the chassis.

4. The automated retail shelf unit of claim 1, wherein the detecting feature comprises a touch screen.

5. The automated retail shelf unit of claim 1, wherein the payment feature comprises a card reader and logic for communicating with a payment switch.

6. The automated retail shelf unit of claim 1, wherein the dispensing feature comprises a ramp for delivering product items from the product storage compartment.

7. The automated retail shelf unit of claim 1, further comprising a processor and electronic memory.

8. The automated retail shelf unit of claim 7, further comprising logic, stored on the electronic memory and executable by the processor, for communicating between the processor and a data center located outside the retail environment.

9. The automated retail shelf unit of claim 7, wherein the processor and/or the memory is configured to identify to the customer via the user interface section one or more product items for purchase by the customer.

10. The automated retail shelf unit of claim 9, wherein the one or more identified product items are located with the retail environment outside of the automated retail shelf unit.

11. The automated retail shelf unit of claim 10, wherein the processor and/or the memory is configured to provide to the customer, via the user interface section, information about location of the identified one or more product items in the retail environment.

12. The automated retail shelf unit of claim 1, wherein the chassis comprises a display for presenting product information corresponding to the one or more saleable product items within the chassis.

13. The automated retail shelf unit of claim 12, wherein the display is located outside the user interface section.

14. The automated retail shelf unit of claim 1, wherein the dispensing feature is configured to prevent unauthorized retrieval of product items from the product storage compartment.

15. The automated retail shelf unit of claim 1, wherein the automated retail shelf unit is configured for automated collection of inventory information corresponding to remaining numbers of the one or more saleable product items in the secure storage location.

16. The automated retail shelf unit of claim 1, wherein the automated retail shelf unit is configured to report the inventory information to another computer system in the retail environment.

17. The automated retail shelf unit of claim 1, further comprising a barcode scanner for scanning barcodes of the one or more saleable product items while these items are being dispensed by the dispensed feature.

18. The automated retail shelf unit of claim 17, wherein the barcode scanner is configured for scanning barcodes of product items available in the retail environment outside of the automated retail shelf unit and wherein the user interface section is configured to provide product information corresponding to the scanned barcodes of the product items available in the retail environment outside of the automated retail shelf unit.

19. An automated retail shelf unit for vending product items to customers, the automated retail shelf unit comprising:
a back side comprising at least two support hooks for attaching to posts of a retail shelving unit, the two supports hooks positioned at a distance of between about 2 feet and feet;
two product storage compartments attached to the back side, the two product storage compartments are configured for storing the product items in a secure manner, wherein the two product storage compartments comprise between 2 and 30 product bins, each product bin configurable to store a different kind of the product items and equipped with a delivery mechanism; and
a user interface section attached to the back side and positioned in between the two product storage compartments, the user interface section comprises:
a touch screen;
a payment mechanism comprising a credit card acceptor and a receipt printer; and
a product delivery bin for delivering a purchased product item and preventing unauthorized retrieval of other product items, a portion of the product delivery open to the product compartments of the two product storage compartments attached to the back side.

20. A method of purchasing an product item from an automated retail shelf unit, the method comprising:
detecting customer selection of a product item available from a product storage compartment of the automated retail shelf unit, wherein detecting is performed by a detecting feature of a user interface section provided on a front side of a chassis of the automated retail shelf unit, wherein the product storage compartment securely stores one or more saleable product items within the chassis;
accepting and processing a cashless payment from the customer for the selected product using a payment feature of the user interface section; and
dispensing the product item selected and paid for by the customer using a dispensing feature of the user interface section,
wherein the chassis of the automated retail shelf unit is sized and configured to fit on an elevated shelf in a retail environment.
